(19) United States
(12) Patent Application Publication
(10) Pub. No.: US 2004/0117275 A1
(43) Pub. Date: Jun. 17, 2004

(54) Telephony-based inventory access system especially well suited to accessing of inventories in the travel industry

(76) Inventor: Donna Christine Billera, Santa Monica, CA (US)

Correspondence Address: BROWN RAYSMAN MILLSTEIN FELDER & STEINER, LLP, SUITE 711, 1880 CENTURY PARK EAST, LOS ANGELES, CA, 90067, US

(21) Appl. No.: 10/678,502

(22) Filed: Oct. 3, 2003

Related U.S. Application Data
(60) Provisional application No. 60/416,109, filed on Oct. 3, 2002.

(51) Int. Cl. G06F 17/60

(52) U.S. Cl. 705/28

(57) ABSTRACT

In an inventory access system, an integrated voice recognition module with a speech processor is used to interface a user with an intelligent switch having access to databases containing profiling information about travelers or criteria regarding limitations on travel established by corporations and having access to the inventories of various travel providers, such as the seats available on an airline's flights, the rooms available in a hotel, or the cars available from a rental car agency. The inventory access system automates a great degree of the travel booking process such that, in the majority of cases, the user does not need to invoke the assistance of a live travel agent. Thus, travel arrangements can be made more efficiently and with less expense than can be accomplished using other systems in which a greater degree of human assistance is required.

### CROSS REFERENCE TO RELATED DOCUMENTS

This claims the benefit of U.S. Provisional Application No. 60/416,109, filed Oct. 3, 2002, which is hereby incorporated herein by reference.

### COPYRIGHT NOTICE

A portion of the disclosure of this document contains material that is subject to copyright protection. The copyright owner has no objection to the facsimile reproduction by anyone of the document or any portion of the disclosure therein, as it appears in the files or records of the U.S. Patent and Trademark Office, but otherwise reserves all copyrights whatsoever with respect to the document.

### BACKGROUND OF THE INVENTION

This invention relates generally to inventory access systems and, more particularly, to inventory access systems that use integrated voice recognition (“IVR”) technology or similar technology to translate input from human users to permit those users to access, search and obtain delivery of items in the inventory quickly and with minimal need for human assistance. The inventory access system according to the invention is especially well suited to accessing inventory in the area of travel, such as airline ticket reservations and hotel, rental car and local ground transportation reservations. It is an attractive alternative to the inventory access offered by the various travel Internet Service Providers (“ISP”s), because only a telephone is needed to use the system and a user can be connected with a “live” travel agent upon a spoken request to do so. The system nevertheless optimizes the expense and time associated with live travel agents, by keeping to a minimum the number and kind of situations in which their assistance will be needed.

Inventory access in any industry can be a daunting task, owing to such factors as the nature of the inventory, the level of sophistication concerning the manner in which the inventory is stored and/or accessed, as well as the type of access to the inventory that is required, the frequency with which the inventory changes, and the costs that are associated with servicing the computers, managers, and suppliers of the inventory. In the travel industry, for example, and with reference to passenger seats in particular, inventory access is complicated by the fact that the systems of the transportation and travel industry from which availability and pricing information are obtained date back to the 1960s. These systems often referred to as “Computer Reservation Systems” or “CRS”s, typically consist of a booking interface and a transaction-processing mainframe which is configured to communicate with the booking interface. At the time the CRSs were developed, they were intended as “off-line” systems, that is, the only way in which a travel agent could confirm price or availability information was via telephone or telex. The 1960's-era CRSs sometimes are referred to as “legacy” systems, owing to their age and far-reaching effect on inventory management in the travel industry. While the airlines are beginning to take steps to transition from these legacy systems to more sophisticated and flexible systems with updated technology, from an information technology or “IT” standpoint, the legacy CRSs or remnants of them will have to be dealt with by any system which seeks to access airline inventory for some time to come.

In the 1980s, when the airline industry was deregulated, a way of electronically distributing inventory information to travel agencies was developed. Such electronic distribution systems were coined “Global Distribution Systems” or “GDS”s. A GDS permits multiple travel agencies to have access to the inventories (e.g., seat availability and pricing information) of multiple inventory suppliers, in this case, the airlines. (Modernly, a variety of travel “products” other than airline seats are accessible by GDSs, for example, hotel rooms, train seats, ground transportation and rental cars.) When they were first introduced, access to GDSs was limited to travel agents, who were specially trained on how to interpret and interact with the GDS system information. Modernly, however, travel Internet Service Providers can obtain access to GDSs. A given user, e.g., an independent travel agency or a corporate travel department or “CTD,” is identified to a GDS manager as an authorized user by reason of a unique terminal address and branch access code or pseudo city code that is assigned to each travel agency or CTD.

Although a particular GDS may be sponsored by a particular travel supplier or a group of travel suppliers (e.g., the GDS managed by the company SABRE, Inc. was initially sponsored by American Airlines), most airlines make their inventory available via all of the GDSs by virtue of contracts between the travel suppliers and the GDSs that provide marketing and commission terms. Nevertheless, there currently are some airlines whose inventory is either hosted exclusively on the airline's own proprietary platform (e.g., Southwest Airlines, Inc.) or on a third-party platform (i.e., the platform known under the trade name OPEN SKIES) that may or may not be accessed via a GDS. An advantage of a GDS to a traveler or to the traveler's travel agent is that the air, hotel and car aspects of a trip itinerary can be integrated into a single record, which record is commonly referred to as a Passenger Name Record or “PNR.”

Notwithstanding the fact that intermediaries such as GDSs are involved with the inventory of the airlines, the airlines maintain control over their inventory by relying upon an economic model known as “yield management,” which is a method of calculating the best pricing policy for optimizing profits from the sale of a seat on an airline flight.

With the advent of the World Wide Web (“www”), travel Internet Service Providers (“ISPs”) evolved as an intermediary between the clients (i.e., travelers and, when applicable, the companies paying for the travel), on the one hand, and the GDSs and the CRSs, on the other. A travel ISP typically is based on a standard three-tier client/server system architecture, wherein client devices (e.g., personal computers with web browsers or a Wireless-Application-Protocol (“WAP”)-enabled device) interface via middleware programming with the GDSs and CRSs. The middleware allows communication between the client device and the GDSs and CRSs, notwithstanding that each of these components might use different protocols. The middleware thus often is referred to as a “booking engine” or a “switching engine.”

The switching engine primarily functions to convert information from one format to another, as appropriate, so that the components can communicate. Travel ISPs usually use basic hypertext markup language (“HTML”) to display information, but an industry association is working on standards for the more versatile and sophisticated extensible markup language (“XML”).

To some extent, travel ISPs address the resource issues associated with providing a “live” assistant, e.g., a travel agent or an airline employee, in order to complete certain transactions. This is an advantage to whichever entity otherwise would have to absorb the costs of these personnel, for example, in the form of overhead, salary, premium pay for after-hours services, commission for an travel agent's services, etc. For obvious reasons, however, the complete elimination of human assistance in the travel booking process is both impractical and undesirable. It is highly desirable in any travel inventory system to insure that human assistance is available to insure that a client's specifications can be met, for example, when a traveler has special needs, and to insure client satisfaction, for example, when a customer has complaints. Indeed, when a system is highly automated, permitting occasional but direct and expeditious access to human assistance is often fundamental to countering any frustration the client might have with the automated system in the first instance.

Travel ISPs have proven to be popular with clients, based on the significant increase in the number of so-called “messaging hits” that are being directed to GDSs or CRSs in order to obtain availability and pricing information regarding travel inventory. In many cases, however, the present state of the technology of the GDSs and CRSs is not sophisticated enough to handle the increased volume of incoming requests. While a human assistant may not necessarily be able to handle a client's transaction any faster than an automated system such as a travel ISP, the ability to access a human assistant for customer service nevertheless may help to appease clients who would otherwise give up on a proposed transaction out of frustration or insecurity as to whether the transaction is the best result for them under the circumstances.

In order for any automated inventory access system to be viable, it must permit the supply of transaction information for administrative purposes, such as accounting, quality control and auditing. In the travel industry, for example, each transaction typically must be accounted for by the airlines, the GDSs where implicated, and the travel agencies or CTDs where implicated. The supply of this information is often referred to as “settlement and fulfillment” or “back office accounting.” Travel accounting processes may be governed in part by certain rules and regulations, such as the audit trail requirements set by the Airlines Reporting Corporation (“ARC”).

Various systems are in place or are being experimented with to ease the travel industry's overall reliance on human assistants, so that the attendant costs associated with maintaining those assistants can be reduced. For example, several airlines make use of telephony technology to offer voice-prompted automated services that allow a caller to obtain information about the status of a particular scheduled flight, e.g., whether the flight is on time or has been-cancelled. These voice-prompted services, however, typically are proprietary to particular airlines or to particular GDSs, such that no single telephony system permits access to status information concerning multiple airlines. Similarly, and to the extent voice-prompted systems exist that permit a client to create a trip itinerary without intervention of a human assistant, such systems also are airline-specific, and no one system exists that can be used to access the inventories contained in multiple airline CRSs or multiple GDSs.

Thus, two obvious disadvantages to booking travel using a travel ISP are that (1) a client needs a computer (or perhaps a Wireless Application Protocol or “WAP” enabled device) in order to access airline availability and pricing information; and (2) access to a live travel agent generally is not provided or is severely limited.

There thus has been a need for an integrated system for accessing travel inventory that uses a simple, ubiquitous interface, such a the common telephone, to allow a travelers or their representatives or agents to automatically obtain availability and pricing information concerning travel products and services, as well as, optionally, a lot of other pertinent travel-related information, and further allows a user to connect to a live travel agent at any time with a simple spoken request.

### SUMMARY OF THE INVENTION

Briefly, and in general terms, the present invention provides a system and method by which a client may access information concerning the inventory of multiple suppliers of travel products and travel services automatically via a telephony interface, and with the option of obtaining a direct connection to a live travel agent on any day or at any time. More particularly, and by way of example and not necessarily by way of limitation, the system and method according to the invention allows a client, who may be a traveler or someone acting on behalf of a traveler, via integrated voice recognition (“IVR”) technology and predefined scripts to which the telephone user is prompted to respond, to ascertain availability and pricing information concerning one or more seats on specific scheduled airline flights from among multiple carriers, and to create a trip itinerary or Passenger Name Record (“PNR”) corresponding to any seat on any flight a client chooses to reserve. At any time in the course of a client's interaction with the system of the invention, the client can transfer out of the system to a live travel agent, by reason of a connection that is automatically accomplished by the system.

The system and method according to the invention also can be configured to allow a client automatic access to inventories of other types of travel products and services, such as available rooms in a hotel, available cars in a rental car fleet, trains and ground transportation to and from airports and hotels.

In addition, the system and method according to the invention may also make available to a client via voice interaction with the system over a telephone numerous other features that are pertinent to travel, such as the following: (1) determining status information regarding an existing scheduled flight concerning anticipated departure or arrival times, terminal and gate information, and whether a flight has been cancelled; (2) calling up a pre-existing reserved itinerary to reconfirm it (as might be required by a given airline in the case of, for example, an international flight); (3) calling up a pre-existing reserved itinerary to ascertain/hear the details of the itinerary; (4) setting up a “watch” on a particular flight, which will cause the system to automatically monitor the status of a scheduled flight over a predefined sampling interval; and (5) interacting with the system by voice to update information, such as credit card information, in a travel profile.

In the case of the frequent traveler, the system and method of the invention offers other desirable features that enable a client to (1) expedite the process of creating a travel itinerary based on information about travelers that have been previously inputted into the system in a traveler-specific “travel profile”; (2) allow the creation of travel itineraries only in accordance with a set of pre-defined criteria, e.g., the business travel restrictions of a particular corporation); (3) expedite the process of creating a travel itinerary for trips to frequently visited destinations, by prompting the client to select from among a group of pre-defined travel itineraries for such frequently visited destinations; (4) cancel a pre-existing itinerary; (5) allow the creation of an alternative travel itinerary only in circumstances when cancellation of a pre-existing itinerary has been confirmed; (6) interact with the system by voice to finalize a pre-existing itinerary to shield against price changes and penalties associated with modifying a PNR within 72 hours of the scheduled departure of the first flight segment in an itinerary; and (7) allow for the automatic creation of a replacement itinerary when an airline has cancelled a flight.

Finally, and from the perspective of the airlines and the independent travel agencies or Corporate Travel Departments (“CTDs”) with which the system and method of the invention interfaces, the system and method provides information about transactions that are accomplished using the system in a form that is compatible with various accounting practices and rules affecting such transactions, including the ARC audit trail provisions.

In presently preferred embodiments of the system and method according to the invention, the interface with the GDSs and CRSs is accomplished with a front-end telephony interface based on IVR technology, a database of libraries concerning client information such as travel profiles, business rules, and quality control and accounting criteria, and a middleware switching engine that can accommodate the multiple protocols of the telephony components and the database, on the one hand, and the GDSs and legacy CRSs, on the other.

The present invention is available either as an alternative to a travel ISP or as an enhancement to an independent travel agency, commercial airline or Corporate Travel Department (“CTD”) that seeks to optimize personnel costs. The system and method of the invention offers the immediate ability to reduce overhead costs of call center or after-hours operations. The present invention enables automated access to the inventory of multiple travel providers for products and services to allow availability and pricing information to be obtained, and for reservations to be booked. Other desirable features of the present invention that allow costs to be controlled are realizable through the automation of complex transactions and high-volume transactions that are currently dependent on live personnel or travel ISP include: (1) the process of canceling a previously existing travel itinerary or PNR by a traveler; (2) the modification of a pre-existing travel itinerary by a traveler; (3) the updating of traveler information in a travel profile or a PNR; and (4) the recording and monitoring customer practices and behaviors as they relate to the corporation services or products.

### BRIEF DESCRIPTION OF THE DRAWINGS

The present invention is illustrated in the figures of the accompanying drawings which are meant to be exemplary and not limiting, in which like references are intended to refer to like or corresponding parts, and in which:

FIG. 1 is a schematic illustrating several of the components of a system according to the present invention.

FIGS. 2a-2c comprise an illustration of an example of a travel profile form used in a preferred embodiment of a system according to the invention.

FIGS. 3a-3b comprise an illustration of an example of business rules that might be used in a preferred embodiment of a system according to the invention.

FIG. 4 comprises an illustration of an example of quality control criteria that might be used in a preferred embodiment of a system according to the invention.

FIGS. 5a-5b is an illustration of an example of a finished trip itinerary or Passenger Name Record (PNR) resulting from use of a preferred embodiment of a system according to the invention.

FIG. 6 is a schematic contrasting the open-market system architecture to the market system architecture that typically characterizes the airline industry.

FIG. 7 comprises an illustration of a trip template as stored in a travel profile that might be used in preferred embodiment of a system according to the invention.

FIG. 8 comprises an illustration of a scripted “dialogue” between a client and a preferred embodiment of a system according to the invention, for determining whether a client is an authorized user of the system.

FIG. 9 comprises a schematic illustration of the process undertaken by a preferred embodiment of a system according to the invention, when the system determines whether a client is an authorized user of the system.

FIGS. 10a-10b comprise an illustration of an example of scripted “dialogue” between a client and a preferred embodiment of a system according to the invention, for creating a trip itinerary with fares such as a round trip airline flight itinerary or a Personal Name Record (“PNR”).

FIG. 11 comprises a schematic illustration of the process undertaken by a preferred embodiment of a system according to the invention, when the system creates a trip itinerary with fare such as an airline flight itinerary with two segments or round trip airline itinerary or a Personal Name Record (“PNR”).

FIG. 12 comprises an illustration of an example of scripted “dialogue” between a client and a preferred embodiment of a system according to the invention, for creating a trip itinerary or PNR according to a predefined “trip template.”

FIG. 13 comprises a schematic illustration of the process undertaken by a preferred embodiment of a system according to the invention, when a client creates a trip itinerary or a PNR using a trip template.

FIG. 14 comprises an illustration of an example of scripted “dialogue” between a client and a preferred embodiment of a system according to the invention, when a client wishes to retrieve information from a preexisting trip itinerary or PNR.

FIG. 15 comprises a schematic illustration of the process undertaken by a preferred embodiment of a system according to the invention, when information from a preexisting trip itinerary or PNR is retrieved.

FIG. 16 comprises an illustration of an example of a script “dialogue” between a client and a preferred embodiment of a system according to the invention, when information from a preexisting trip itinerary or PNR is cancelled.

FIG. 17 comprises a schematic illustration of the process undertaken by a preferred embodiment of a system according to the invention, when information from a pre-existing itinerary or PNR is canceled.

FIGS. 18a-18b comprises an illustration of an example of a script “dialogue” between a client and a preferred embodiment of a system according to the invention, when information from a preexisting trip itinerary or PNR is modified.

FIGS. 19a-19b comprises a schematic illustration of the process undertaken by a preferred embodiment of a system according to the invention, when information from a pre-existing itinerary or PNR is modified.

FIG. 20 comprises an illustration of an example of scripted “dialogue” between a client and a preferred embodiment of a system according to the invention, when a client wishes to set up a “watch” on a scheduled airline flight.

FIG. 21 comprises a schematic illustration of the process undertaken by a preferred embodiment of a system according to the invention, when a “watch” for a scheduled airline flight is set up.

FIG. 22 comprises a schematic illustration of the process undertaken by a preferred embodiment of a system according to the invention, when a “watch” for a preexisting itinerary with a scheduled airline flight is set up and results in a cancellation and a new PNR is created by system.

FIG. 23 comprises a schematic illustration of the process undertaken by a preferred embodiment of a system according to the invention, when a “watch” for a preexisting itinerary with a scheduled airline flight is set up and results in a cancellation and a new PNR is created by system.

FIG. 24 comprises an illustration of an example of scripted “dialogue” between a client and a preferred embodiment of a system according to the invention, for obtaining flight information.

FIG. 25 comprises a schematic illustration of the process undertaken by a preferred embodiment of a system according to the invention, when a client obtains flight information.

FIG. 26 is an illustration of an example of scripted “dialogue” between a client and a preferred embodiment of a system according to the invention, when a client wishes to be connected with a travel agency.

FIG. 27 is a schematic illustration of the process undertaken by a preferred embodiment of a system according to the invention, when a client is connected with a travel agency.

FIG. 28a is a schematic illustration of an example of a scripted message sent from a preferred embodiment of a system according to the invention, to a user's telephone (or e-mail address) whereby the client is reminded to make changes to preexisting trip itinerary or PNR before incurring penalties.

FIGS. 28b and c are schematic illustrations of examples of scripted messages sent from a preferred embodiment of a system according to the invention to a user's telephone (or e-mail address) whereby the client is prompted to update information in the client's profile information.

FIG. 29a is a block diagram illustrating interaction of a preferred embodiment of a system according to the invention with the quality control queues of a Global Distribution System.

FIG. 29b is a schematic illustration of the steps in the process when a preferred embodiment of a system according to the invention interacts with the quality control queues of a travel agency database.

FIG. 30 an illustration of an example of scripted “dialogue” between a client and a preferred embodiment of a system according to the invention, when a client is prompted to update a credit card expiration date stored in the client's travel profile and/or PNR.

### DETAILED DESCRIPTION OF THE PREFERRED EMBODIMENTS

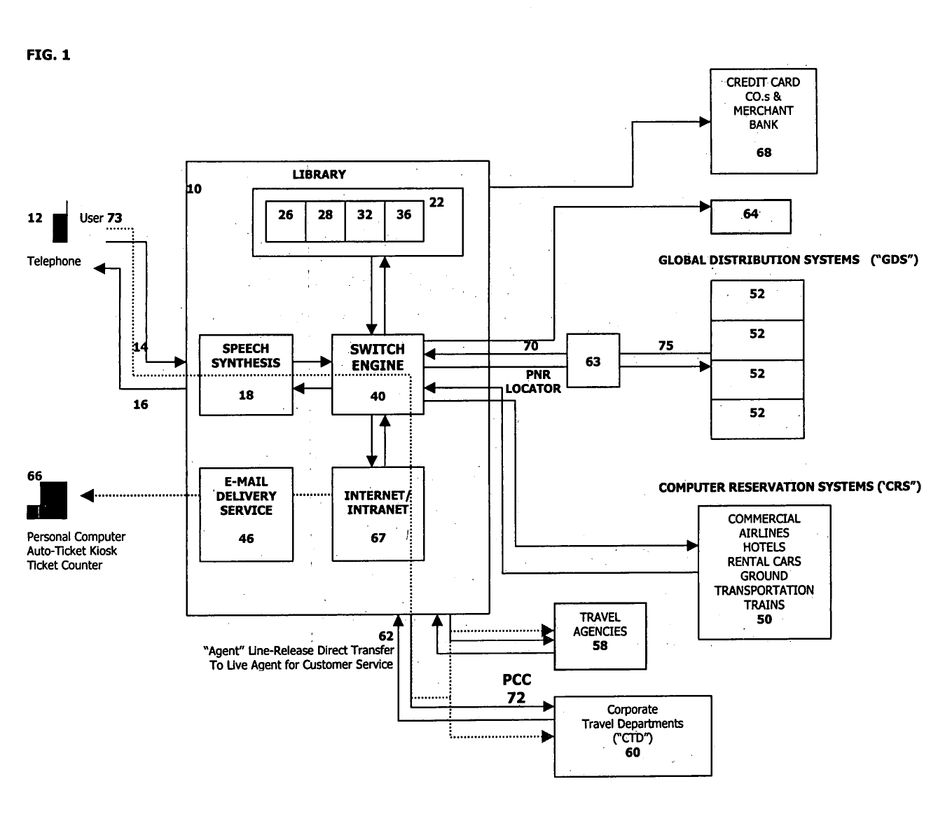

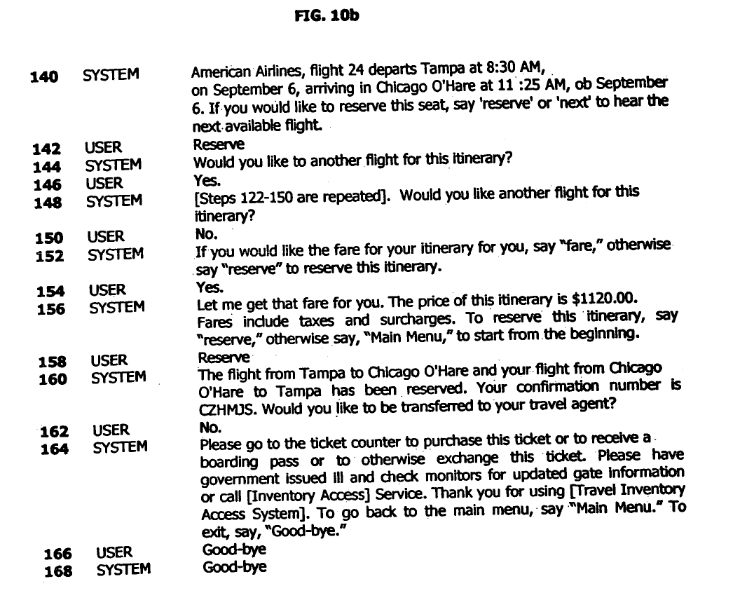

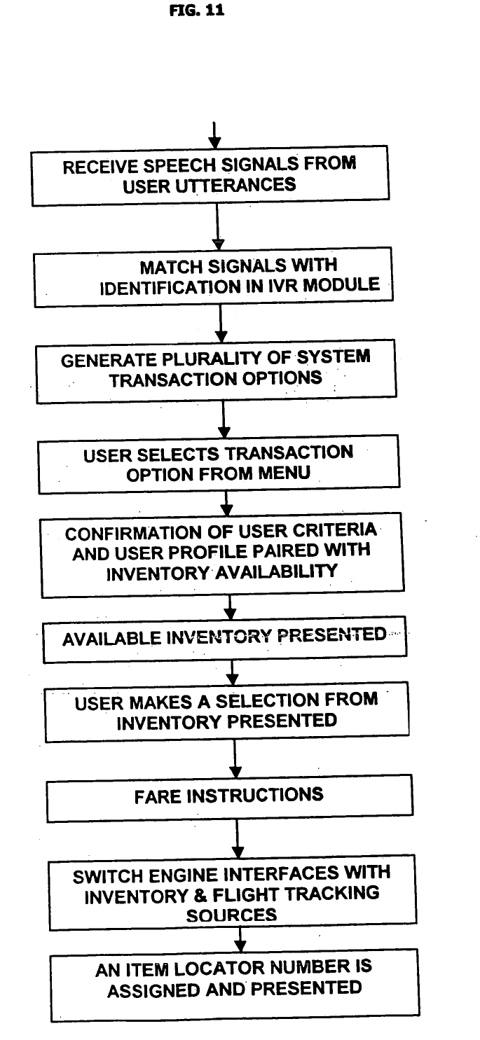

The preferred embodiments of an inventory access system and method according to the invention are discussed with reference to the drawings in FIGS. 1-30.

FIG. 1 illustrates in schematic form an inventory access system 10 in accordance with a preferred embodiment of the invention. The inventory access system 10 is comprised of several basic components. First, a client interface 12 is provided over which voice information can be sent to, and transmitted from, the rest of the system. A speech synthesis module 18 is provided to accomplish the translation of information that is input by a user 73 via a client interface 12 into a form or protocol that the system can understand, and to accomplish the translation of information that is sent by the system back to the client interface 12 into a form or protocol that the client can understand. A library 22 is provided which contains a variety of relational databases containing such things as identification/authorization information 26 (information with which a given client may be identified as an authorized user of the system, travel profiles 28, corporate business rules 32 concerning any limitations on corporate travel, and quality control criteria 36 for insuring compliance with any applicable business rules or accounting procedures.

At the heart of the system, a middleware switch engine 40 is provided that is capable, on the one hand, of accepting and processing the information from the speech synthesis module 18 and the library 22 and, on the other hand, of accepting and processing information from the systems which contain the information concerning the inventory of a given supplier's travel products and services, e.g., an airline's Computer Reservation System (“CRS”) 50, a global distribution system (“GDS”) 52, an airline inventory of available seats, hotel inventory of open rooms, or a rental car agency's available cars to lease. The switch engine 40 is uniquely designed to accept data that is formatted according to multiple protocols, e.g., the protocols that characterized the circa 1960's legacy CRS architecture, and to manipulate and reconfigure that data so that it can be processed and therefore acted upon more quickly than would otherwise be possible. For example, the switch engine 40 can accept data in a six-bit format and translate it into an eight-bit format, which leads to faster processing of information.

The switch engine 40 also has the capability of connecting the client to a particular travel agency 58 or corporate travel department 60, upon receipt of a request from the client to do so at the client interface 12. The switch engine 40 further has the capacity to automatically send information concerning completed transactions to, for example, the CRSs 50 and the GDSs 52 by way of a computer gateway 63 (which can be implemented by a direct line or via Internet), and to the travel agencies 58 and CTDs 60 for accounting purposes, such as settlement and fulfillment. Optionally, the inventory access system 10 of the invention may include an adjunct client interface 46, over which information concerning a client's travel itineraries to be transmitted to a computer over the Internet or an intranet 67. As a further option, the inventory access system 10 of the invention may include direct connections 64 to services or agencies that provide airline flight tracking information, such as Global Positioning Systems, radar systems or the Federal Aviation Administration (“FAA”). Additionally, the inventory access system 10 of the present invention may include direct connections 68 to credit card companies and merchant banks, so that the system might accomplish the verification in real time of a client's credit card information for the completion of transactions.

In presently preferred embodiments of a system and method according to the invention, the device of choice for the primary client interface 12 is a telephone, either land-based, cellular or satellite. It is contemplated that, as other technologies develop, that the primary client interface 12 might comprise any device that is as widely available, transportable and easy to use as the telephone. Information from the client interface 12 is inputted to the inventory access system 10 via input ports 14 and information from the inventory access system 10 is outputted to the client interface 12 via output ports 16.

In a preferred embodiment, the client interface 12 communicates with the input ports 14 and the output ports 16 via a high-speed data line, such as a T1 line that is capable of carrying digitized voice data at high rate per second. The speech synthesis module 18, which communicates with the input ports 14 and the output ports 16, preferably is an integrated voice recognition (“IVR”) module that is implemented with computer telephony hardware and software that is used to translate signals between telecommunications networks and computer systems. The currently preferred hardware is comprised of a telephony interface card manufactured under the trade name “ANATARIES II” by Intel Corporation; a graphical development kit that uses an application supportive of telephony technologies that is sold under the trade name “VOS,” by Parity Software Development Corporation and that can be used with the computer operating system “WINDOWS NT” available from Microsoft Corporation; and voice processing boards assigned the part number D/41EPCI by Intel Corporation. In one preferred embodiment, commercially available “voice portal” software, such as that sold by Redmond Software, is configured, in a manner that would be apparent to one with ordinary skill in the art, to enable users to access information or allows the inventory access system 10 to send voice and data over a telephone, and also is used in connection with the input ports 12 and the output ports 14. The voice portal software ensures the connectivity between two disparate telephone networks exists to transport voice and data messages between the inventory access system 10, the user and travel agencies 58 or Corporate Travel Departments 60. In one preferred embodiment, commercially available “voice recognition” software, from Nuance Communications, Inc., is configured, in a manner that would be apparent to one with ordinary skill in the art, in the speech synthesis module 18 to enable the inventory access system 10 to recognize client utterances for voice authentication in library 22 and to convert those utterances into recognizable commands to manipulate the inventory access system 10.

The library 22 comprises a collection of databases that can be hosted on any suitable personal computer or dedicated server, such as the computer offered by COMPAQ under the model number DL580. There is no limit to the nature and kind of the information that is stored in the library 22 for use by the inventory access system 10. In presently preferred embodiments, however, the library contains databases including the following:

(1) An identification/authorization database 26, containing information by which a given client of the system can be identified as an authorized user of the system, such as a user name and password, and stored samples of a user's speech utterances that might be used for voice authentication;

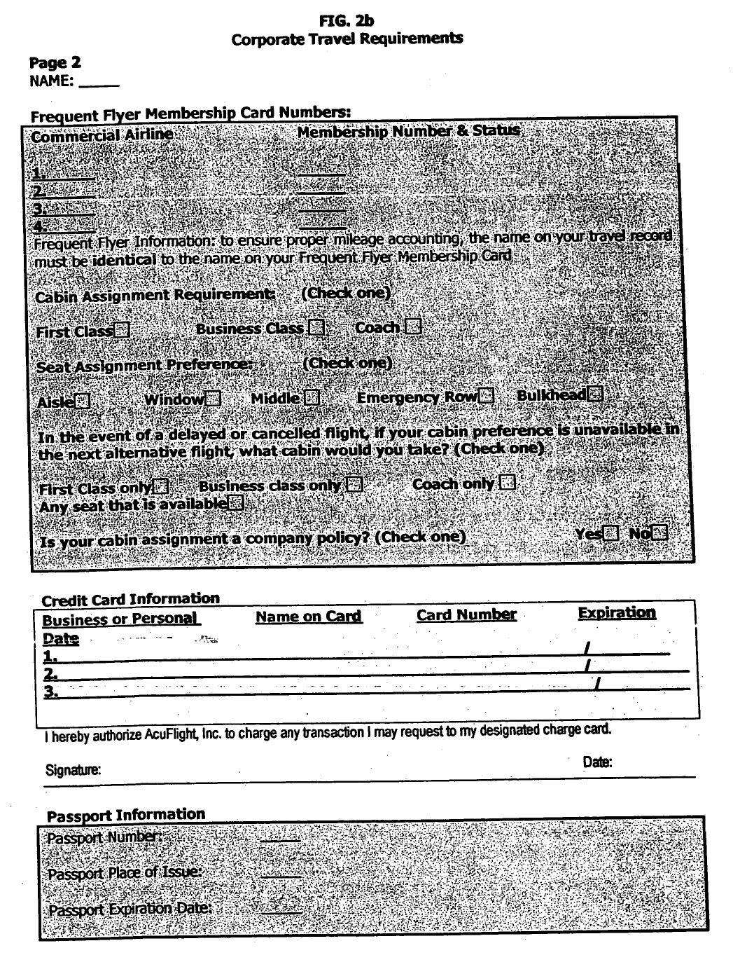

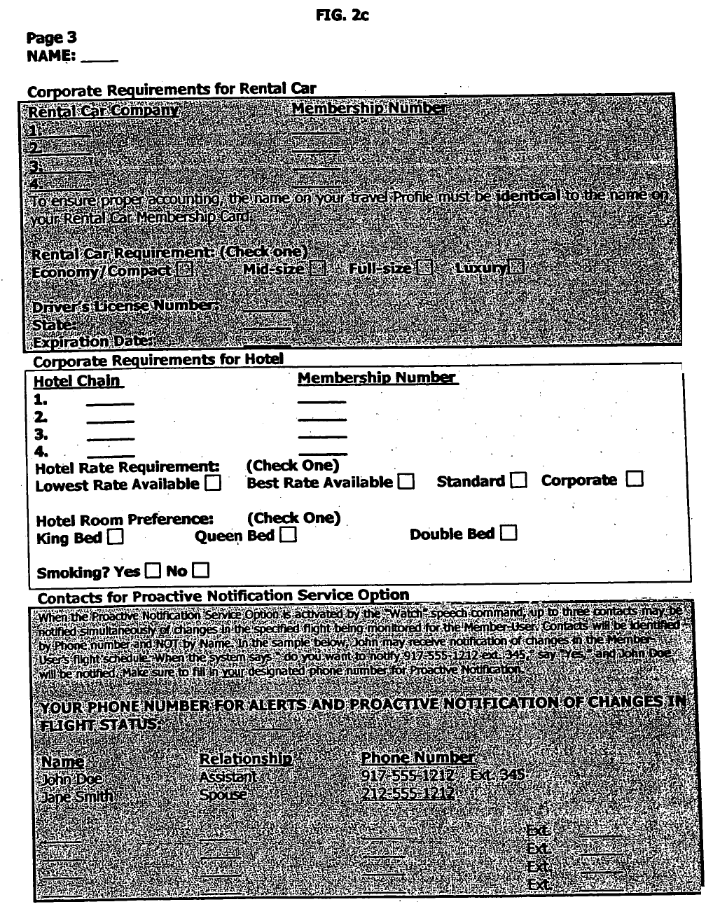

(2) A database of travel profiles database, that contain information about individual travelers such as the traveler's contact, credit card and billing information, as well as any corporate or business affiliation and travel agency information. An example of the types of information that might be included in a typical travel profile is provided in FIGS. 2a-2c.

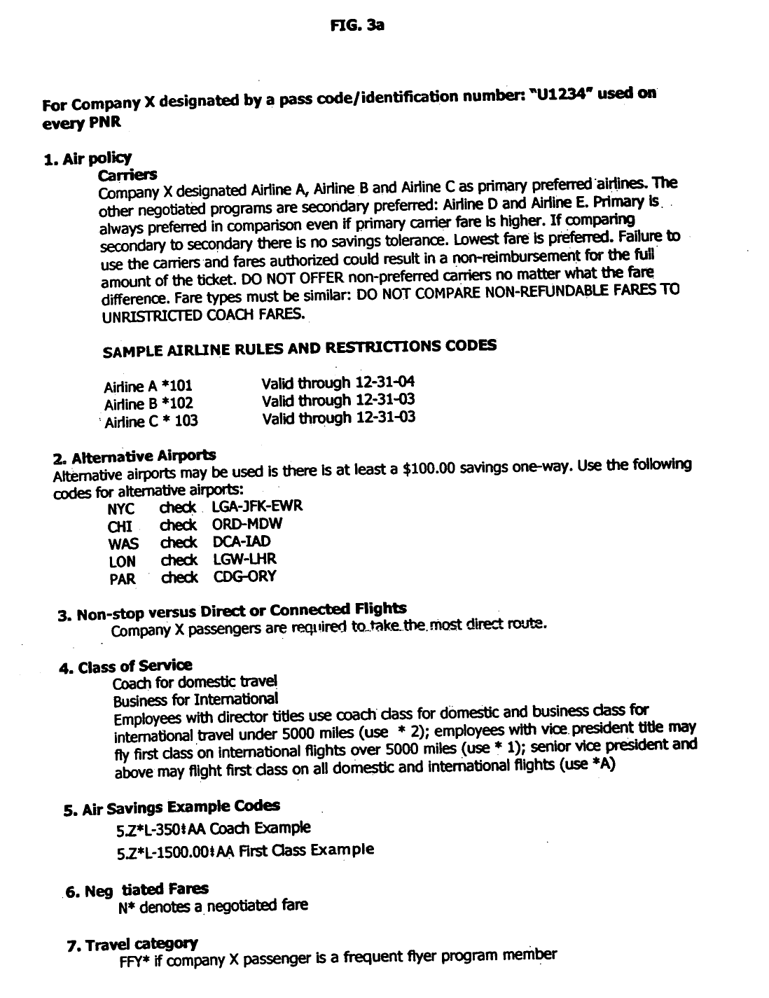

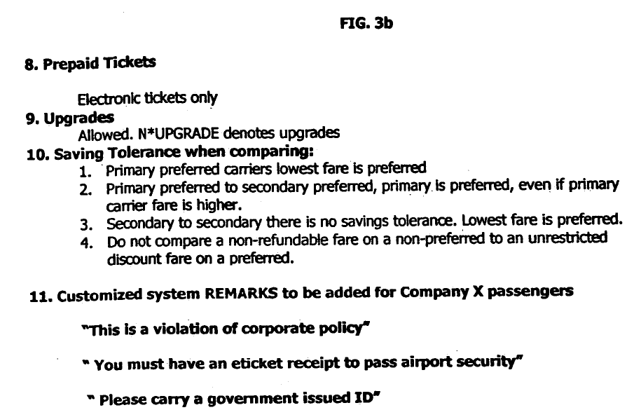

(2) A database of business rules 32 which set forth any policy restrictions a given corporate client might impose on its employee travelers, such as restrictions on the class of air travel (e.g., business class for executives, economy class for rank-and-file employees) or restrictions on fares (e.g., requirements to use fares that have been pre-negotiated between a company and a given airline (“contracted” or “contract” fares), together with any remarks that a corporation wishes to have accompany a traveler's trip itinerary (e.g., “please carry your government-issued I.D”). An example of the types of information that might be included in a typical set of business rules is provided in FIGS. 3a-3b;

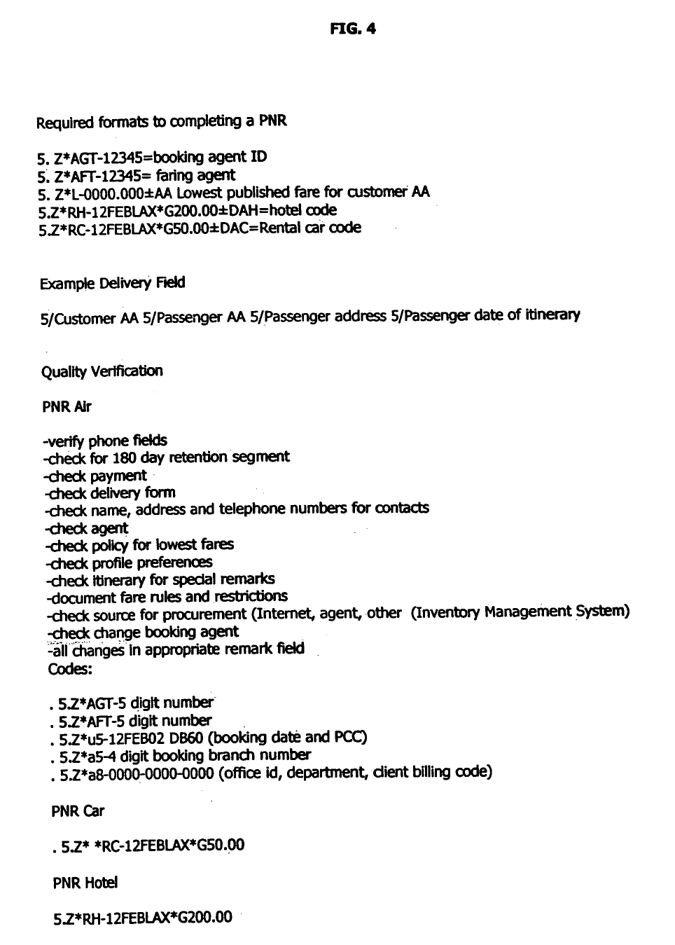

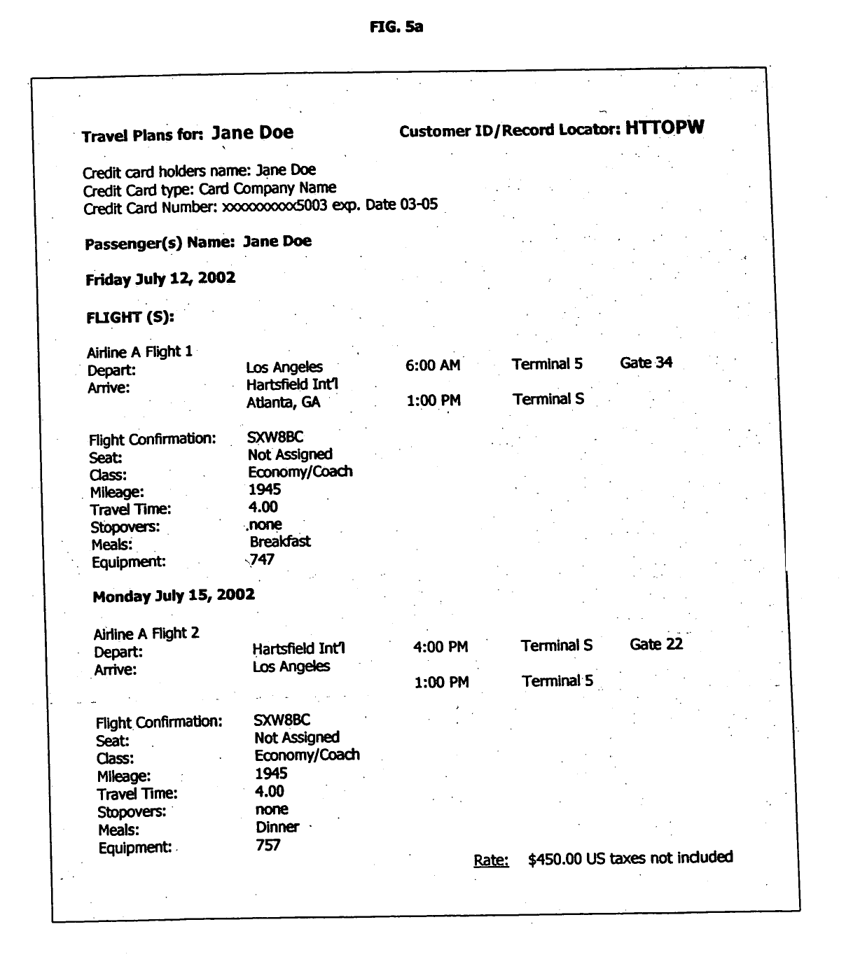

(3) A database of quality control criteria 36 for insuring client compliance with any applicable business rules, auditing procedures or accounting procedures (e.g., limiting air travel by certain pricing or rate calculation criteria, maintaining a “ghost” of all transactions completed using the system so that the “ghost” information may be transmitted to the suppliers of the travel products and services or to the travel agencies and Corporate Travel Departments for r reconciliation). The database information concerning settlement and fulfillment functions, or “back office accounting” for completed transactions, is often referred to as “finishing files” in travel industry parlance. An example of the types of information that might be included in database a quality control criterion is provided in FIG. 4a.

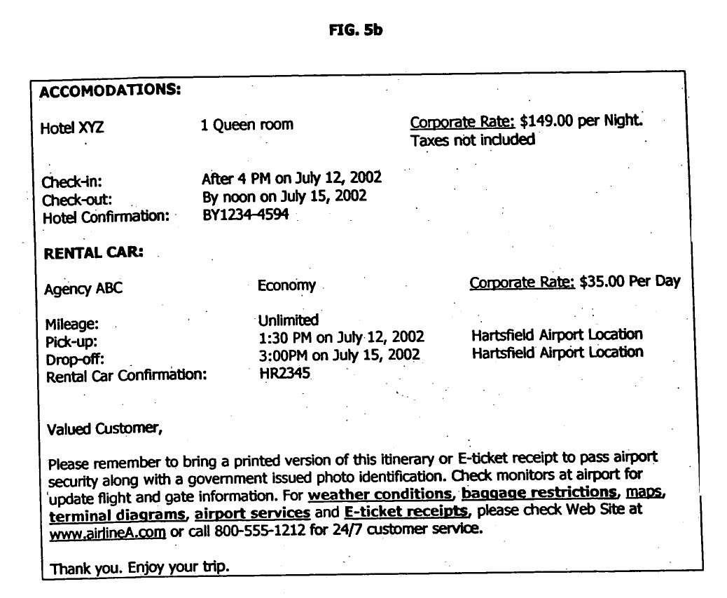

An example of a “finished” trip itinerary or “populated” PNR 28 is provided in FIGS. 5a-5b.

A currently preferred switch engine 40 for use with a presently preferred embodiment of the invention is configured from a combination of hardware and software developed by The Eastman Group under the trade name “AUTOLINK.” In a preferred embodiment, the switch engine 40 is configured especially to fit the needs of those in the travel and transportation industry. The switch engine 40 is a multitasking, multiprocessing, multiprotocol-enabled module that can accomplish a high-speed interface between various different architectures, protocols and systems through a gateway 63 comprising a hardware and software the appropriate combination of which would be apparent to one skilled in the art. In a presently preferred embodiment of the system according to the invention, the combination of hardware and software being used is a combination sold under the trade name “INNOSYS.”

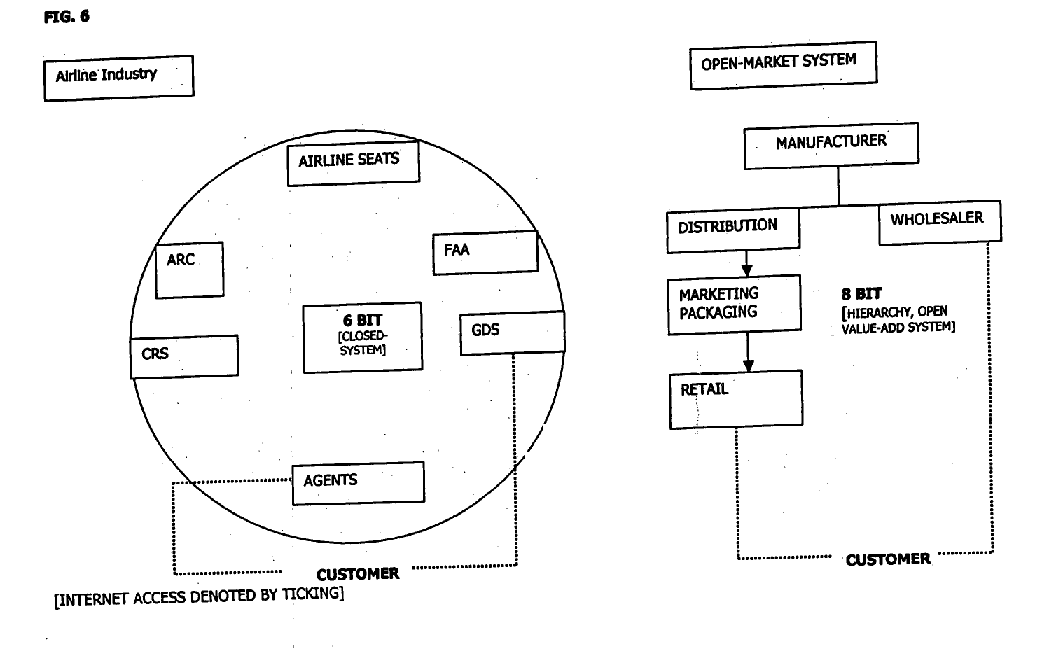

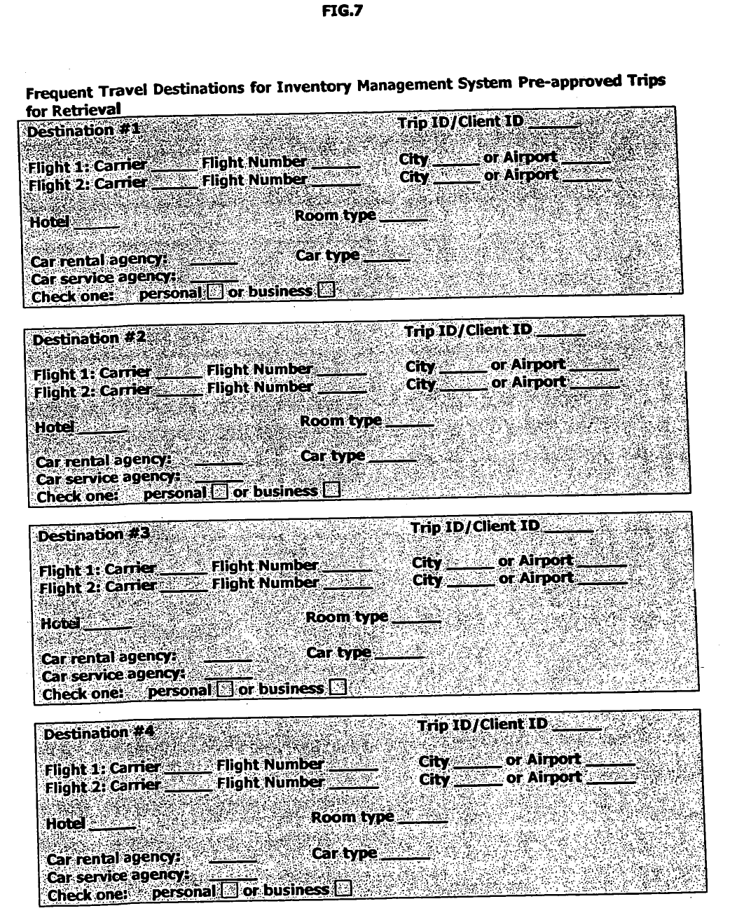

The switch engine 40 assists in the management and processing of information associated with different formats and/or protocols. For example, the inventories of the airlines, and by association, those of the travel GDSs that are linked to the airline inventories, typically are stored within legacy system architecture that dates back to the 1960's. In this “legacy” architecture, information is stored and manipulated in a six-bit format. The AUTOLINK switching engine 40 of a preferred embodiment can convert the six-bit data to an eight-bit format, which makes the data compatible with most so-called “open market” systems (e.g., marketing/packaging systems, wholesaler systems, etc.) that are accessible via the Internet or via an Intranet. A schematic illustration of a comparison between of an open-market system and the market system typically encountered in the travel industry with respect to available airline seats is provided in FIG. 6.

The adjunct client interface 46 in a currently preferred embodiment according to the invention is an e-mail service, such as the e-mail service available under the trade name “CAPITARIS” from Capitaris, Inc. While the inventory access system 10 according to the invention does not require a client to possess a personal computer or a Wireless Access Protocol (“WAP”)-enabled device, a currently preferred embodiment of the system of the invention does have the capacity to transmit via e-mail to client's personal computer 66 and to contact persons designated by clients, certain information that is pertinent to a traveler. For example, a client may have delivered via e-mail electronic copies of trip itineraries and/or receipts for completed transactions, and a traveler may specify one or more e-mail addresses to which the traveler wishes the system 10 to provide reminders of upcoming trip itineraries, periodic indicators of the status or progress of a given airline flight, or notifications of cancelled flights, etc.

The various functional features of an inventory access system 10 in accordance with preferred embodiments of the invention will now be described.

Preliminarily, a client must be confirmed as an authorized user of the inventory access system 10. In order to introduce a new client into the system, some basic identifying information about the prospective client must be inputted into the identification/authorization database 26. The information can be collected from the client for input into the system 10 in a variety of ways, such as via a form the client might fill out and then submit the information either via telephone to an operator for the system 10, or via facsimile or over the Internet. A prospective client also will be invited to complete one or more travel profiles for the travelers whose trip itineraries will be booked using the system 10. If the client is an individual, the client might submit travel profiles for himself or herself only, or for his or her family. If the client is a corporation, the client will submit travel profiles for all of the prospective corporate travelers on whose behalf the client might be using the system 10. Alternatively, the inventory access system 10 may receive access to profiles for corporate travelers by way of a dedicated phone line to the corporation's database of travelers or by way of a shared access code, also known as a branch access code or a pseudo city code 72. The pseudo city code is associated with a terminal address (“TA”) for each travel agency or Corporate Travel Department (“CTt)”). The terminal address allows the travel agencies or CTDs to access PNRs in the GDSs or CRSs.

The nature of the information that might be included in a travel profile includes, but is not limited to, the following: the traveler's name, address, telephone number and e-mail address (if any); the particulars of any credit card or corporate account that is to be charged for the trip; any frequent flyer program memberships and membership numbers for the traveler; a designated person to be contacted in the event of an emergency and the telephone number or e-mail address or e-mail addresses for that individual; designated contacts, other than the traveler himself or herself, who are to be notified in the event of an change, expected or unexpected, in one of the traveler's itineraries (e.g., a changed flight or a delayed flight); identifying information for the live travel agent the traveler has chosen or to which the traveler is assigned by his corporate travel office (e.g., the travel agent's telephone number and the travel agency's pseudo city code (PCC) 72. An example of a typical travel profile is provided in FIGS. 2a-2c.

Where a traveler is a corporate traveler affected by certain business rules 32, such as fare restrictions or carrier restrictions, a code or codes corresponding to the pertinent set of rules will be added to the travel profile so that, whenever the travel profile is accessed by the system 10, the system 10 will identify and apply the appropriate set of business rules 32. Similarly, a set of quality control rules applicable to a given traveler or travelers can be linked to the travel profile(s) by inserting a code into the profile(s) that corresponds to the quality control rules.

Further, more sophisticated travel profiles may include more specific information either about the traveler, or the mode of travel or the accommodations (e.g., information regarding age, left-handedness, gender, Global Positioning System (“GPS”) coordinates for destinations, etc.) For travelers who travel to and from the same destination often, the travel profile information may also include “trip template” information, which identifies a traveler's or a corporation's frequently used and/or preferred airlines, travel routes, and flights, and perhaps information as to whether there is a preferred hotel and whether a rental car likely will be required. An example of a trip template is provided in FIG. 7. As is the case with the client identification/authorization information, individual travel profile and trip template information can be transmitted to the system for entry in the appropriate database in the library 22 by an appropriate means, such as via telephone, facsimile or Internet (e.g., via a link from the client's website to a website of the inventory access system 10).

Upon processing of a prospective client's information, the system 10 will assign the client some preliminary identification codes, such as a user name or access code and a password, to prepare the client for initial use of the system 10. Identification codes may also be assigned by a client's CTD 60 or travel agent/agencies 58 to further direct client information to certain queues for further processing or to certain personnel for immediate processing (e.g., in instances where international travel is associated with additional conditions that must be satisfied in order to complete booking, in the circumstance in which a traveler is changing pre-existing travel plans as reflected in a pre-existing PNR, or where a pre-existing PNR is Otherwise required to be changed, so as to conform it to V.I.P. business rules or, alternatively, to rank-and-file employee business rules).

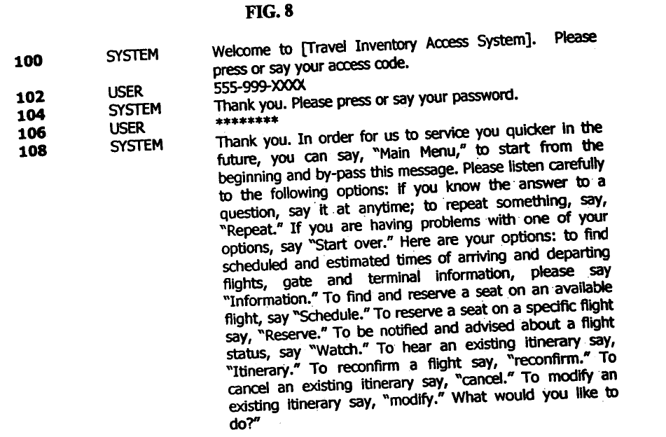

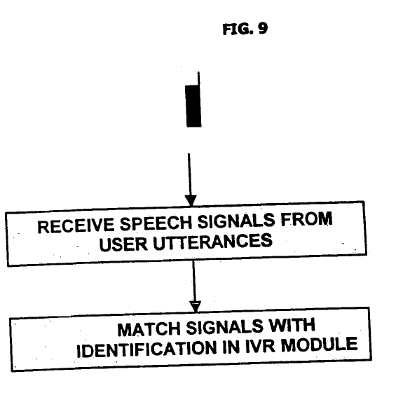

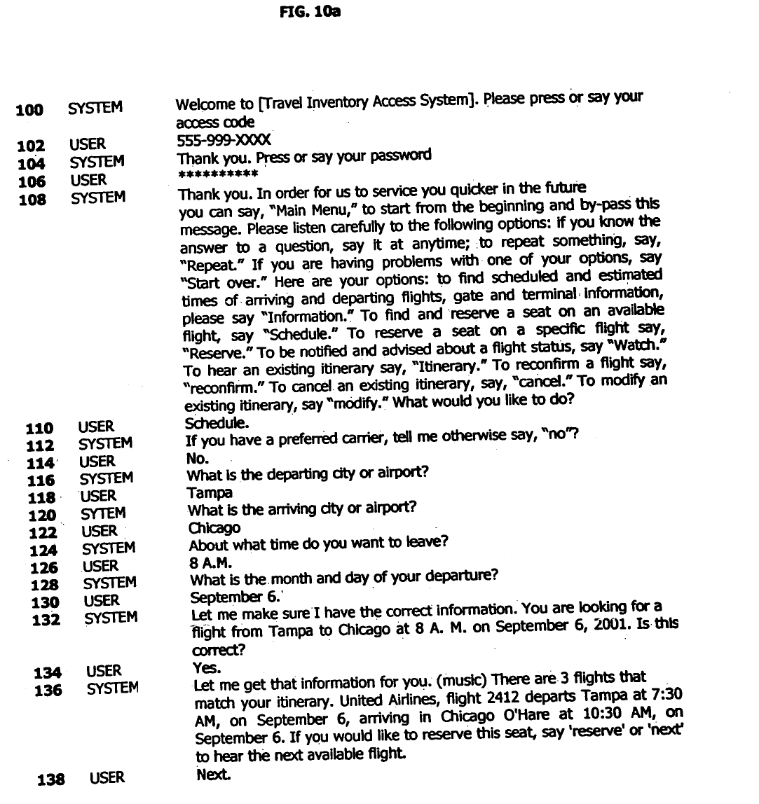

Referring now to FIG. 8, when the client first calls into the system 10, the client will be asked to speak the user name or access code or, alternatively, to enter it via a touch tone keypad 100 of the telephone or other client interface. In the event the access code is verified by the system 10 as a valid access code, the client will be prompted to provide the password 104. If the password is verified, the system 10 will respond to the client with an explanation of the available options for use 108. The identification/authorization process is illustrated schematically in FIG. 9. In the course of a client's initial use of the system 10, the client's utterances are stored in the identification/authorization database 26 for later use in a voice verification process to confirm that a client is an authorized user of the system 10. Voice verification may be used in addition to, or in place of, the access code and password method for identification/authorization. Once the client has been acknowledge by the system 10 as an authorized user, the system 10 will verify the user's stored profile 28. The system 10 will also determine whether the user's stored profile contains codes which correspond to a particular set of business rules that are applicable to that user or to the traveler and, if any such codes exist, will identify the available options to present to the user accordingly. Similarly, the system 10 will determine whether any particular quality control rules 32 or special transaction accounting rules apply. When this has been accomplished, the system will then present the client with a series of transaction options 108 corresponding to the various features of the invention as are described below.

Creating a Trip Itinerary or PNR

One of these options includes creating a trip itinerary or obtaining a Passenger Name Record (PNR) via the “schedule” command 110. This feature of the system 10 now will be explained with references to FIGS. 10a-10b, FIG. 11 and FIGS. 5a-5b.

Preliminarily, the client is prompted by the system 10 to provide information concerning the airline of choice 112, 114, the departure and arrival cities or airports 118, 122, the preferred hour of departure 124, 126 and the desired date of travel 128, 130. Once the system 10 has this information, the system 10, confirms the information 132 and then, via the switch engine 40 and switch engine gateway 63, will query the suppliers' inventories, e.g., as available in the CRSs 50 or the GDSs 52, to find matches with the client's criteria. While the system 10 is searching for the information and/or waiting for the CRSs 50 or the GDSs 52 to respond, it is contemplated that the client will be provided with “hold” music or advertisements or some combination of the two for a few seconds.

When the information has been retrieved by the system 10, it is processed back through the gateway 63 and through the switch engine 40, through the speech synthesis module 18, and through the output ports 16 to the client interface 12, e.g., the user's telephone. The system 10 relays the travel options sequentially to the client and, after each option is recited, asks the client whether he or she would like to reserve a seat on the available flights 136, 138, 140, 142. Once an option has been selected an reserved, the system 10 queries the client as to whether the client would like to reserve a return flight (or any other flight) 144, 146, 148. If the client responds in the affirmative, the system 10 repeats the process of querying the suppliers' inventories, retrieving and relaying the pertinent information, and taking the client's reservation instructions. The system 10 “sells” the itinerary (as the action is referred to in travel industry vernacular), back to the suppliers' inventories, i.e., the GDSs 52 or CRSs 50, through the switching engine 40 and computer gateway 63 and “holds” this itinerary in the GDS or CRS for the client. Once a client has selected the itinerary by reserving the flights (or hotel rooms or rental car reservations), the system acquires from the GDS or the CRS the fare that corresponds to the itinerary 152, 156.

A finished trip itinerary or Passenger Name Record (PNR) (see the example of a finished or populated PNR in FIGS. 5a-5b) is created only after the client confirms that he or she wishes to purchase the final itinerary 158, 160. A copy of the finished PNR then is automatically sent by the systems to an application that ultimately will deliver the PNR to, for example, a client's designated e-mail-address, via the e-mail delivery service 46. The PNR is accessible to the CRS 50 of the pertinent travel supplier, any GDS 52 that is involved, and the system 10. The PNR also may be accessible to any travel agency 58 or Corporate Travel Department 60 that is authorized for such access by the client or by the travel supplier or the GDS 52. A PNR is associated with a pointer or “PNR locator” or “record locator” 70 that identifies the location of a PNR in a database so that it may be accessed quickly by any party with authorization to access it by reason of a pseudo city code or PCC 72. The PNR locator 70 typically consists of an alphanumeric combination, such as “FH5RS3” or the like.

Optionally, the system 10 completes the scheduling and reservation process by providing the client with remarks and/or instructions that pertinent to that traveler's itinerary, such as the appropriate manner in which to obtain a boarding pass (e.g., “go to the airline's auto-ticketing kiosk), or how to exchange a ticket if necessary (e.g., must see agent at airline ticket counter), or the period of time the traveler should allot for being processed through airport security, or admonishments for the traveler to bring the appropriate identification or other travel documents to the airport 164. To exit the system, the client hangs-up or says, “Good-bye” 166, 168.

At any time during the scheduling and reservation process, the system 10 may ask the user to confirm whether or not he or she wants the assistance of a travel agency 58 or CTD 174. Alternatively, the client can invoke an agent at any time by uttering the command “agent.” In the system 10 of the invention, “agent” is a command that is referred to as a “universal command” in voice recognition technology parlance. The command “agent” in the system 10 will evoke an immediate response whenever it is uttered by a user, regardless of the stage of the particular transaction that is being accomplished. “Agent” will cause the system 10 to interrupt the transaction and divert to the process that corresponds to the command, i.e., the process of connecting the user to the designated travel agent or CTD. Other examples of “universal commands” in the system 10 of the present invention include “repeat,” “start-over,” “good-bye” and “main menu.”

The scheduling of travel arrangements and the creation of trip itinerary or PNR process is illustrated schematically in FIG. 11.

As indicated above, the criteria pursuant to which a given trip itinerary or PNR is created is not necessarily derived solely from a client's spoken responses to queries of the system 10. Rather, the criteria may be limited by one or more sets of business rules 32 that are stored in the library 22 and which proscribe limitations on a particular traveler's travel. For example, business rules may limit the system 10 to search for available airline seats on airlines that recognize and accept government-contracted fares. Other business rules may force the system 10 to limit a search to particular airlines for a given city-to-city route (“city pair,” e.g., Los Angeles/New York)), or use low cost or “discount” airlines whenever feasible.

The inventory access system 10 according to the invention further is capable of maintaining a “ghost” of each transaction (i.e., a copy of each completed trip itinerary or PNR). These ghost transactions can be further used by the system 10 to fulfill accounting or quality control functions such as confirming compliance with business rules.

Creating a Trip Itinerary or PNR Using a Pre-defined Trip Template

As mentioned above, and in addition to allowing a user to configure travel arrangements by starting out with all available flights on a particular day at a particular time, the inventory management system 10 of the invention also allows a user to plan travel by invoking a pre-defined “trip template,” to further reduce the amount of time it takes to create a PNR for a travel itinerary. With reference to FIG. 7, trip template information can be set forth in a traveler's travel profile, detailing such information as first and second choices for preferred carriers on the traveler's bi-monthly trip from his or her Houston office to headquarters in Chicago, the preferred hotel for stays in Los Angeles, and whether a rental car will be required during visits to New York City.

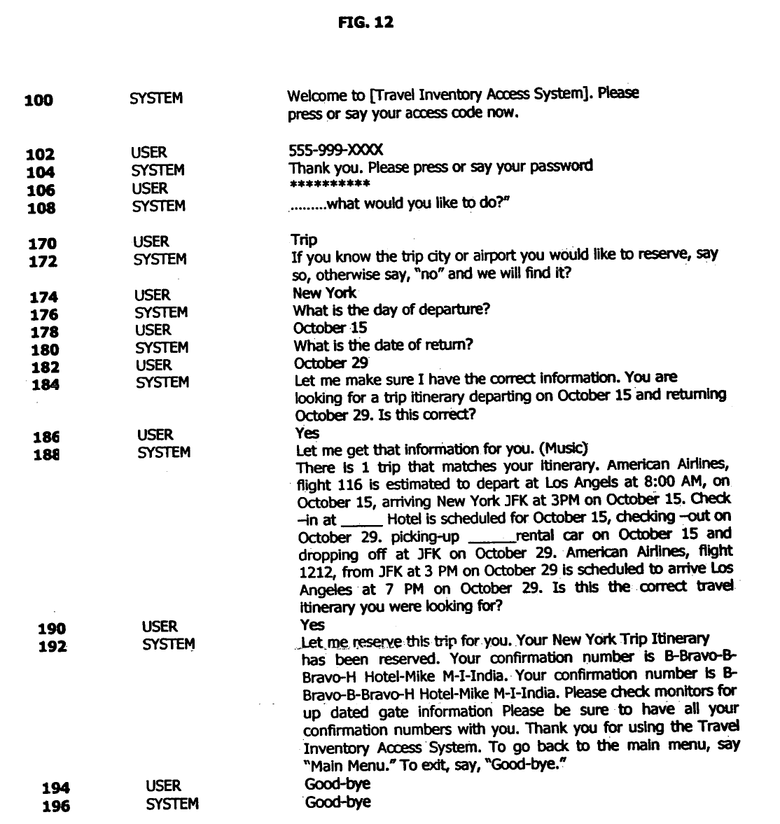

Referring now to FIG. 12, when a user wishes to invoke a pre-defined trip template for a traveler when booking travel arrangements, the user utters the command “trip” 170 after having been identified as an authorized user of the inventory access system 10. The system 10 then prompts the user to choose from several trip templates 172, e.g., Trip City 1, Trip City 2, etc. Normally, the only additional information the system will need from the user after the user's selection of a trip template is the date of departure and date of return 176, 180. The system 10 then confirms the request 184 and then can go find each segment of the itinerary from the suppliers' inventories or airline's CRS 50 or from a GDS 52, and then responds to the user with the pertinent information that matches the information set forth in the relevant trip template 188.

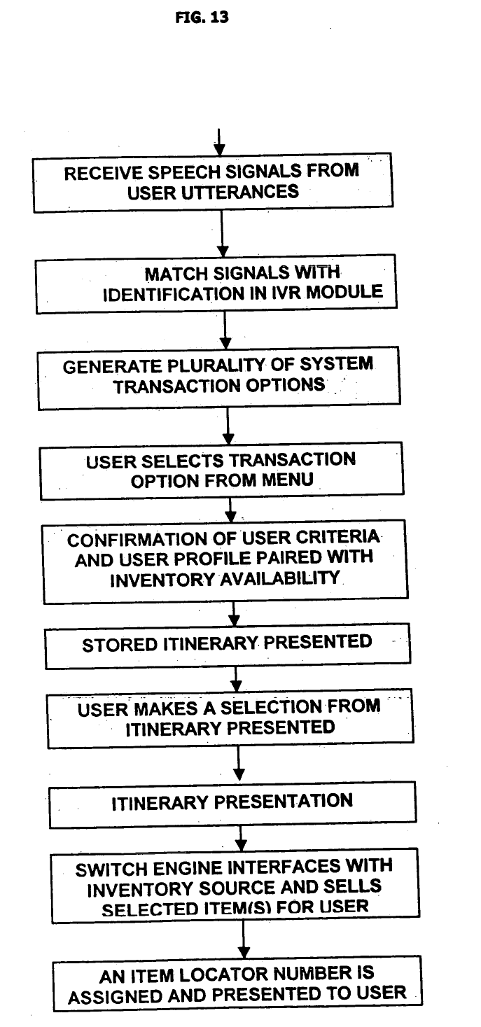

The system 10 “sells” the segments that make up a pre-defined trip template itinerary, back to the suppliers' inventories, the GDSs 52 or CRSs 50, through the switching engine 40 and switching engine gateway 63 gateway, and then “holds” the predefined trip template itinerary in the GDS for the client. Once a client has confirmed the itinerary selected by reserving the predefined trip template 190, the system generates a finished trip itinerary or PNR (see, e.g., FIG. 5) to the client's designated back-end solution application, such as an e-mail-address via the e-mail module 46 or to an airline's self-ticketing kiosk 66 via the e-mail module 46 or some other appropriate means. Lastly, the system 10 relays the PNR Locator 192 through the switch engine 40, the speech synthesis module 18 and the output port 16 to the client interface 12, along with instructions to “start over” or to “exit” by speaking the word, “Good-bye” 194. The scheduling of pre-defined trip itinerary and/or the creation of a predefined trip itinerary or PNR process is illustrated schematically in FIG. 13.

Retrieving Information About a Pre-existing Itinerary

In one preferred embodiment of a system 10 according to the invention, the system 10 can be configured to send certain information about a traveler's itinerary to an authorized user of the system or to a travel agent or corporate travel office for record keeping or accounting purposes, as well as to aid in compliance with any pertinent security rules or Federal Aviation Administration (“FAA”) regulations imposed on airports.

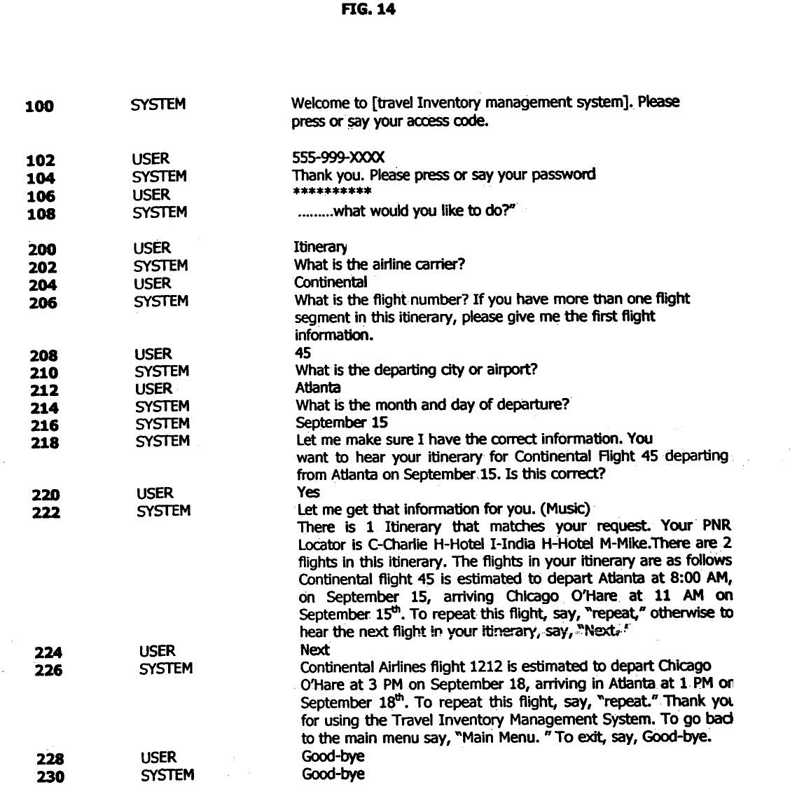

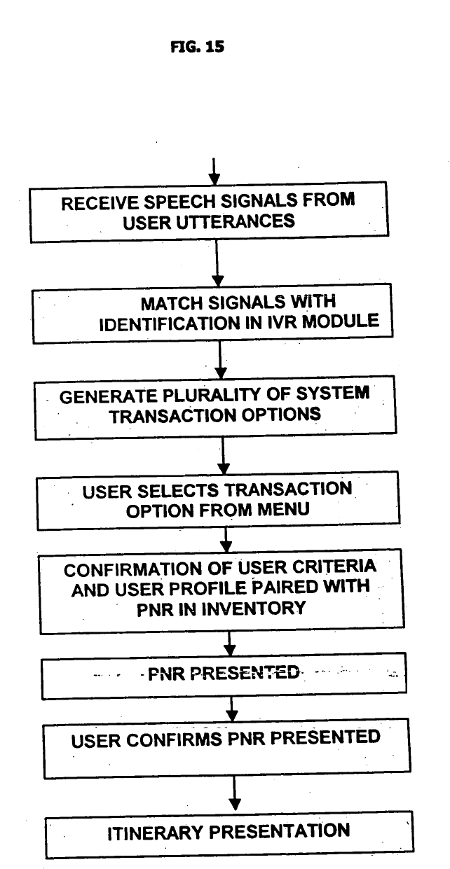

This feature of the system 10 now will be explained with references to FIG. 14 and FIG. 15. FIG. 14 is an example of a system script for this option showing possible user responses. The process by which a client retrieves information concerning a pre-existing trip itinerary or PNR information is illustrated schematically in FIG. 15.

After a user's authorization to use the system 10 has been confirmed, the user utters the command “itinerary.” A pre-existing trip itinerary or PNR must be retrieved in the suppliers' inventories (i.e., the GDS 52 or CRS 50) before it can be relayed to a client or forwarded to an e-mail address that is designated as an e-mail address in a stored travel profile 28. Preliminarily, then, the user is prompted by the system 10 to provide information concerning the pre-existing trip itinerary or PNR that the client wants to retrieve. The user is prompted by-the system 10 to provide information concerning, for example, the airline carrier associated with the pre-existing trip itinerary or PNR, 202, 204, the flight number 206, 208, the departing city or airport of the first flight segment of the pre-existing trip itinerary or PNR 210, 212, and the scheduled date of travel 214, 216. Once the system 10 has this information, the system 10 will retrieve information from the PNR in the GDS or CRS that appears to correspond to the information provided by the user, and will relay it to the user 218, 220. It is contemplated that in one embodiment of the system 10 according to the invention, a user may retrieve information about a given itinerary or finished PNR by simply uttering the PNR locator or record locator 70 that corresponds to the itinerary, e.g., “B-Bravo -H-Hotel -H-Hotel -I-India -M-Mike- C-Charlie.”

While the system 10 is searching for and retrieving the user's actual itinerary information from the pertinent GDS or CRS, the user may be provided with “hold” music, message or advertisement or some combination of two for a few seconds. When the actual itinerary information has been retrieved by the system 10, it is processed back through the gateway 63 and through the switch engine 40, through the speech synthesis module 18, and through the output ports 16 to the client interface 12, e.g., the user's telephone. The system 10 relays sequentially the pre-existing trip itinerary or PNR information regarding flight, lodging and car rental arrangements. The system 10 also supplies the user with the PNR locator for that PNR, so that the user can retrieve the information even more quickly in the future. If an itinerary contains multiple airline flight segments, the system 10 will prompt the user to indicate whether any segment should be repeated after it is relayed by the system 10 for the first time or whether the user wishes to hear information about the next segment 224, 226. The system 10 concludes the “itinerary” transaction by providing instructions to the user as to how to perform another transaction with the system 10 or, alternatively, how to exit the system 228, 230.

Canceling a Pre-existing Trip Itinerary or PNR

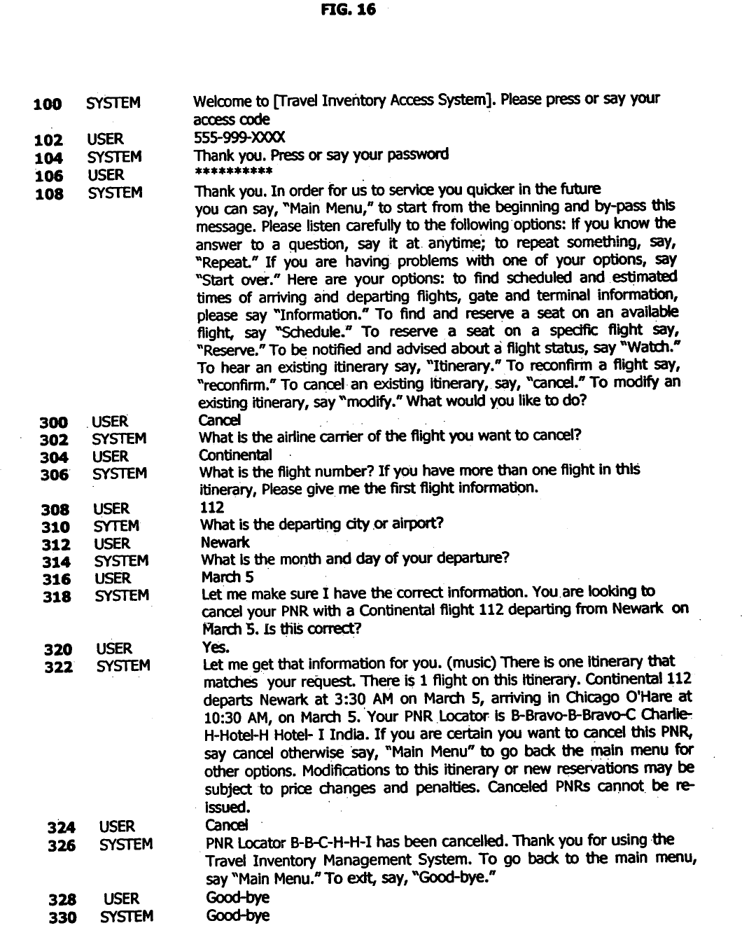

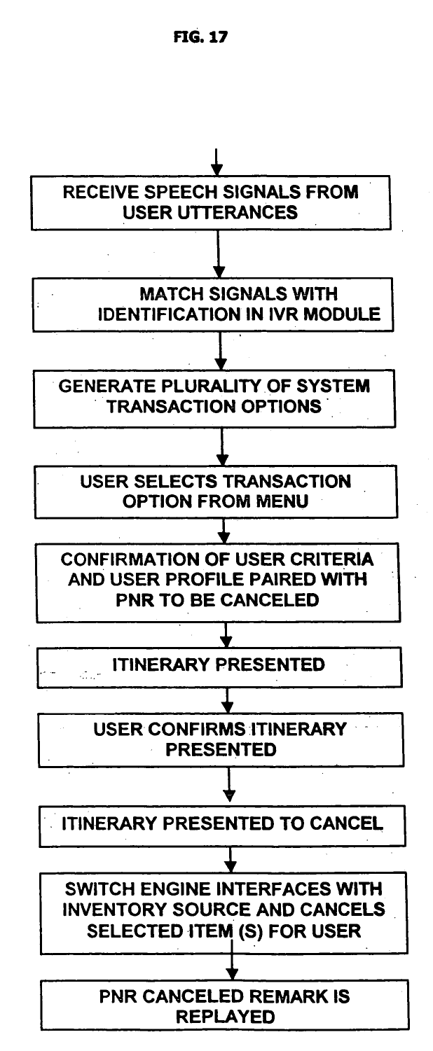

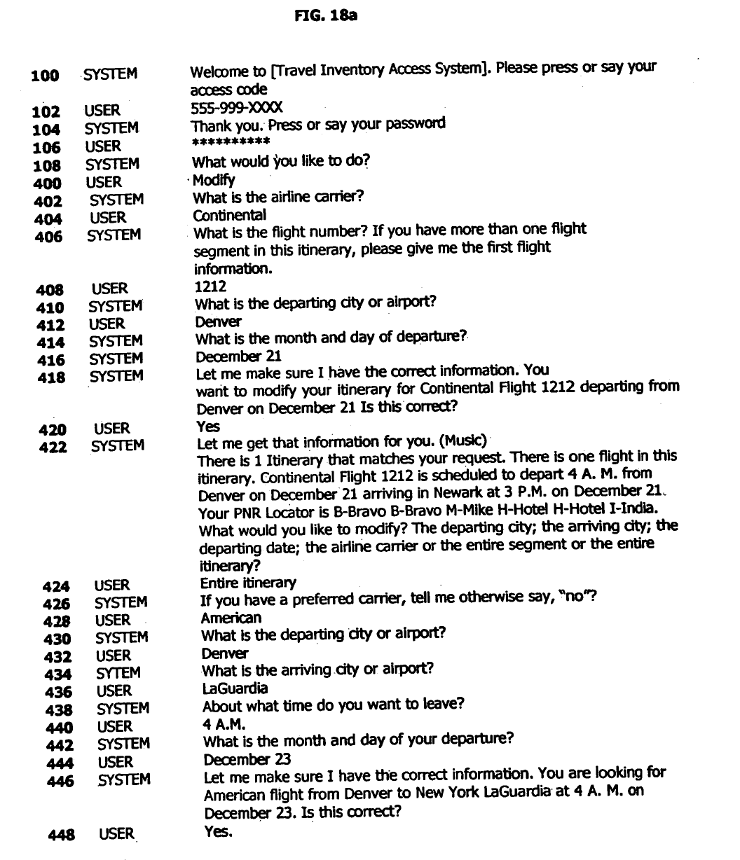

One of the transaction options of the system 10 according to the invention is the option to cancel a pre-existing itinerary or PNR. This feature of the system 10 now will be explained with reference to FIG. 16 and FIG. 17. FIG. 16 is an example of a system script for this option showing possible user responses. The process by which a client retrieves information concerning a pre-existing trip itinerary or PNR information to cancel the PNR is illustrated schematically in FIG. 17.

This transaction option is invoked by the user's utterance of the command “cancel” 300. Information concerning a user's pre-existing itinerary or PNR must be retrieved by the system 10 from the suppliers' inventories (i.e., from the GDS 52 or CRS 50) before it can be canceled. Thus, the user is prompted by the system 10 to provide information concerning the pre-existing itinerary or PNR that the client wants to cancel. For example, the user is prompted by the system 10 to provide information concerning the airline carrier of the pre-existing itinerary 302, 304, the flight number 306, 308, the departing city or airport of the first flight segment 310, 312, and the scheduled date of travel 314, 316. The system 10 then uses this information to retrieve, via the switch engine 40 and the switch gateway 63, from the suppliers' inventories (i.e., the GDS 52 or the CRS 50), information from whichever PNR most closely corresponds with the information supplied by the user. It then compares the information provided by the user with the information that actually appears in the PNR 318, 320. In one embodiment of a system 10 according to the invention, an itinerary to be cancelled may be identified to the system by the user if the user simply utters “cancel” and then, in response to a prompt from the system, utters the PNR locator.

When the information has been retrieved by the system 10, it is processed back through the gateway 63 and through the switch engine 40, through the speech synthesis module 18, and through the output ports 16 to the client interface 12, e.g., the user's telephone. The system 10 relays to the user sequentially the pre-existing trip itinerary or PNR information regarding flight, lodging and car rental arrangements. After the system 10 has recited all of the pertinent information about the subject itinerary to the user, the system prompts the user to confirm that the itinerary should be cancelled. If the client responds in the affirmative 324, the system 10 echoes the user's request to cancel, and relays the fact of cancellation back to the GDS or CRS on which the pertinent PNR is stored. When the itinerary has been cancelled, the user is advised by the system and then presented with the options of conducting another transaction with the system or exiting the system 326, 328, 330. Optionally, the system 10 also provides the user with a confirmation number for the cancellation.

Modifying a Trip Itinerary or PNR

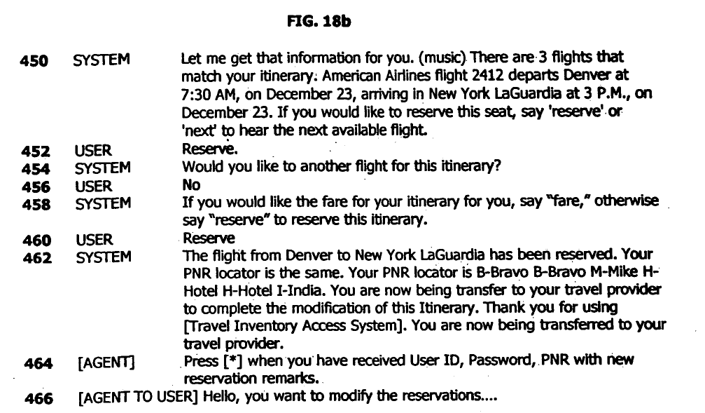

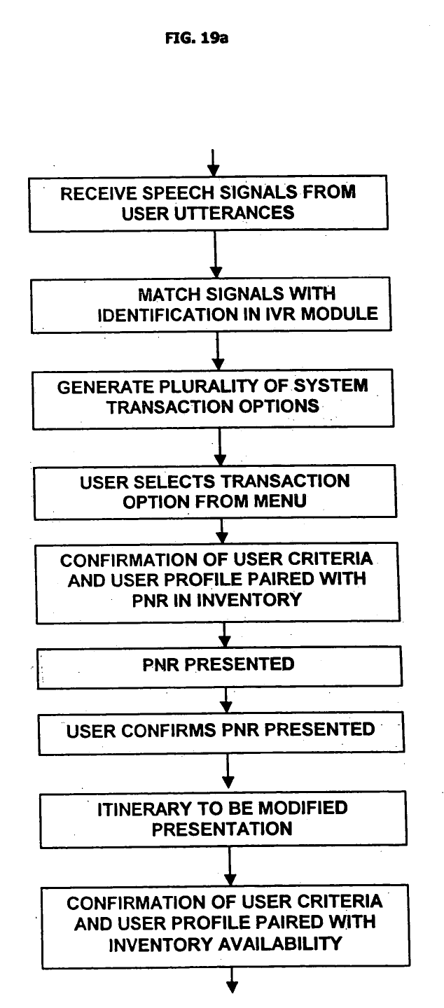

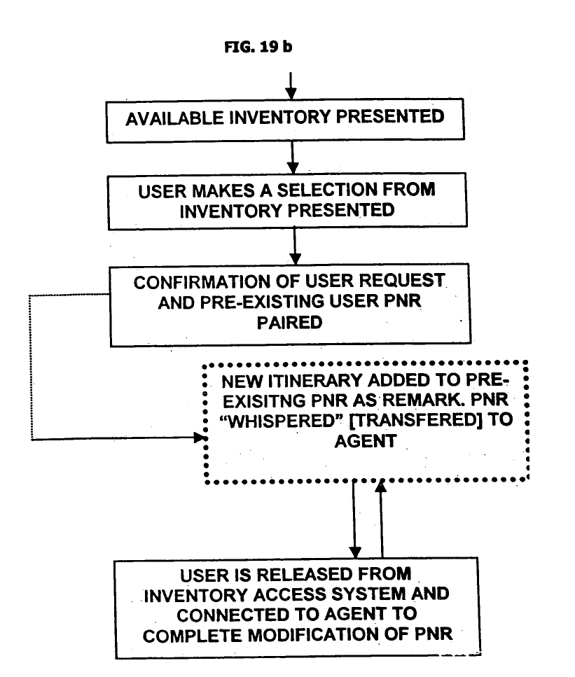

Another of the transaction options of the system 10 according to the invention is the option to modify a pre-existing itinerary or PNR. This feature of the system 10 now will be explained with reference to FIGS. 18a-18b and FIGS. 19a-19b. FIGS. 18a-18b provide an example of a system script for this option showing possible user responses. The process by which a user retrieves information concerning a pre-existing trip itinerary or PNR information to modify a PNR is illustrated schematically in FIGS. 19a-19b.

This transaction option is invoked by the user's utterance of the command “modify” 400. Information concerning a user's pre-existing itinerary or PNR must be retrieved by the system 10 from the suppliers' inventories (i.e., from the GDS 52 or CRS 50) before it can be canceled. Thus, the user is prompted by the system 10 to provide information concerning the pre-existing itinerary or PNR that the client wants to cancel. For example, the user is prompted by the system 10 to provide information concerning the airline carrier of the pre-existing itinerary 402, 404, the flight number 406, 408, the departing city or airport of the first flight segment 410, 412, and the scheduled date of travel 414, 416. The system 10 then uses this information to retrieve, via the switch engine 40 and the switch gateway 63, from the suppliers' inventories (i.e., the GDS 52 or the CRS 50), information from whichever PNR most closely corresponds with the information supplied by the user. It then compares the information provided by the user with the information that actually appears in the PNR. In one embodiment of a system 10 according to the invention, an itinerary to be modified may be identified to the system by the user if the user simply utters “modify” and then, in response to a prompt from the system, utters the PNR locator.

When the information has been retrieved by the system 10, it is processed back through the gateway 63 and through the switch engine 40, through the speech synthesis module 18, and through the output ports 16 to the client interface 12, e.g., the user's telephone. The system 10 relays to the user sequentially the pre-existing trip itinerary or PNR information regarding flight, lodging and car rental arrangements. After the system 10 has recited all of the pertinent information about the subject itinerary to the user, the system prompts the user to confirm that the itinerary should be modified. If the client responds in the affirmative 424, the system 10 repeats the process of querying the suppliers' inventories to retrieve the PNR information, prompts the user to provide instructions as to which aspects of the itinerary are to be modified (e.g., by sequentially prompting the user to make choices with respect to flights, departing city, desired date of departure, etc.) 428, 430, 432, 436, 440, 444.

If the PNR contains a code that corresponds to a set of business rules 32 (e.g., requiring restricted fares or the use of contract fares), the prompts that system 10 provides to the user in the modification process and the changes that the system allows the user to make will be consistent with the requirements of those business rules.

In addition, if the PNR that is modified contains a code corresponding to a set of quality control rules that are stored in the system's library, after a user has decided upon the modifications that are to be made to the itinerary, e.g., by affirming the flight or hotel or car rental reservation 450, the system 10 compares the modified itinerary to the quality control criteria 36 and asks the client whether he or she would like to reserve another flight segment 454, 456 and to have the system provide fare information for the new itinerary 458.

When the modification process has been completed, the system 10 asks the user to confirm the changes. If the user does so, the system 10 “sells” the new itinerary back to the suppliers' inventories (i.e., checks to insure that the desired new itinerary is available in the GDSs or CRSs), through the switching engine 40 and switching engine gateway 63, and then the requested itinerary is held in the suppliers' inventory for the user.

When the client is ready to confirm the itinerary 460, the system 10 generates an “itinerary confirmed” remark and adds it to the corresponding PNR for the new itinerary and provides a copy of the PNR for the new itinerary with the new data to whichever travel agency or CTD is associated with the traveler in the traveler's profile. The system 10 “whispers” 462 the PNR locator number, client ID and pass code to the travel agent/agency or CTD through the switch engine 40, through the speech synthesis module 18 and through the output ports 16 over the system's interface with the travel agency or CTD. The system 10 waits for a signal from the travel agency's or CTD's interface that confirms that the information was received, and once such confirmation has been received, the system terminates the connection with the travel agency or CTD. The user exits the system 10 via the client interface 464, 466.

Setting Up A “Watch” For An Arriving or Departing Flight; Offering Alternative Itinerary For Flights Cancelled By Carrier

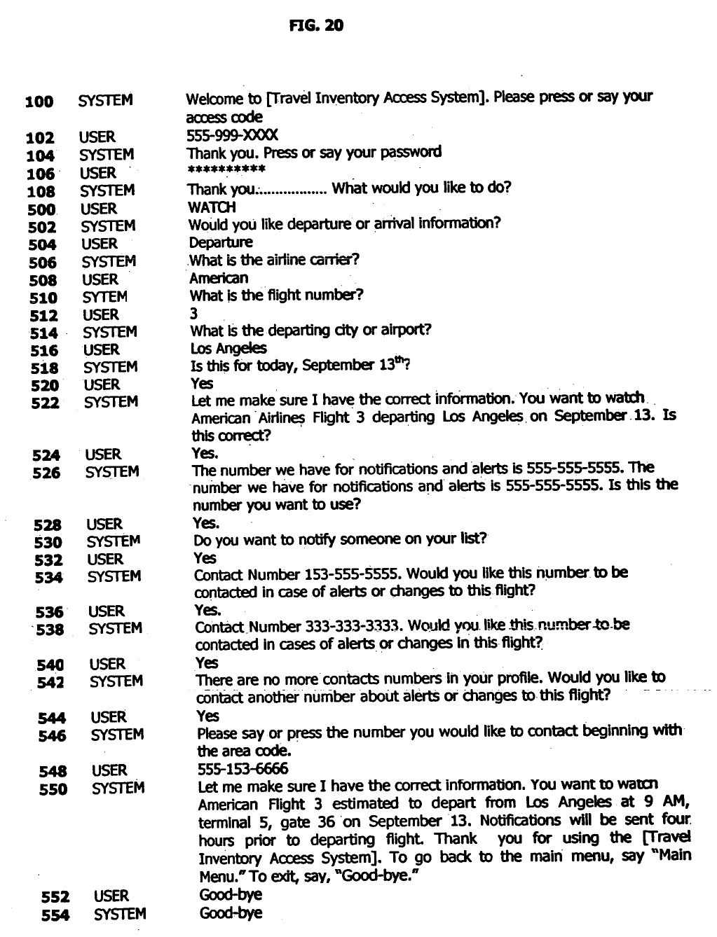

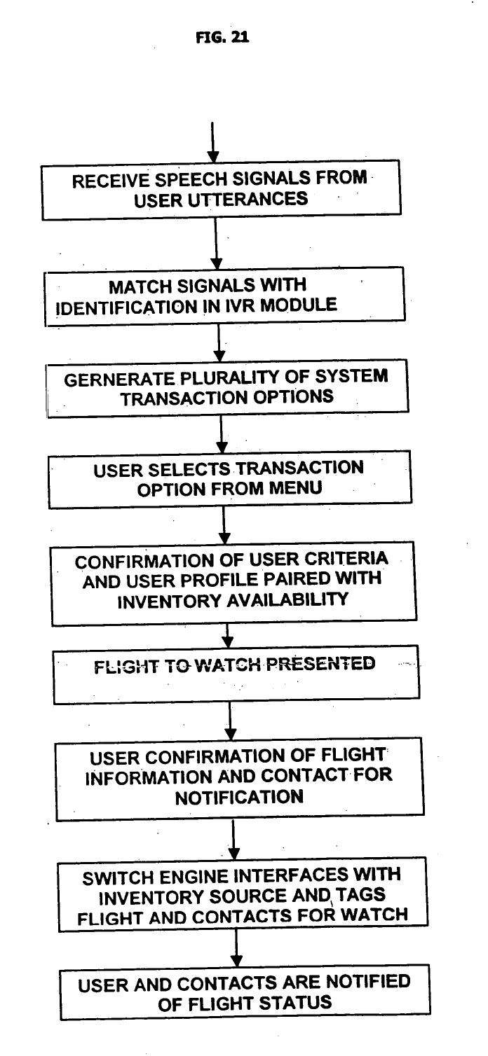

Another of the transaction options of a system 10 according to the invention is the option to monitor a particular flight that is identified by either a flight number or a departure time to obtain arrival or departure information. This feature of the system 10 now will be explained with reference to FIGS. 20 and 21. FIG. 20 is an example of a system script for this option showing possible user responses. The process by which a user retrieves information concerning scheduled flights is illustrated schematically in FIG. 21.

This transaction option is invoked by the user's utterance of the command “watch” 500. In one preferred embodiment of the invention, after a user has been established as an authorized user, the system 10, if the client utters the command “watch” 500, the system 10 will prompt the user to identify a particular carrier 506 and flight number 510 or, alternatively, it will invite the user to identify whether he or she wants departure 502 or arrival information and then the system will prompt the user to provide additional details about the flights in response to questions concerning, for example, the date of the flight, the time of day it is expected to depart or arrive, etc.

Once the system 10 has the identifying information from the user for a given itinerary or flight that is to be “watched” 510, 512, 514, 516, it will monitor information about that itinerary or flight at a pre-determined sampling interval 550. The “watch” option also allows the user to specify to the system a telephone number or telephone numbers or an e-mail address or e-mail addresses to which updated information about the flight of interest will be relayed by the system at periodic intervals. According to one embodiment of a system according to the invention, this periodic interval is pre-determined by the system 10 (e.g., every 15 minutes). According to another embodiment, the system 10 prompts the user to define the notification interval, e.g., every hour on the hour. The source of the information monitored can be any or all of the following: a particular airline's status database, an airline's or another GDS's status database, or a FAA database. For example, the system may be configured to monitor information about a particular upcoming or pending flight every 15 minutes, and provide any alerts or notifications about cancelled or delayed flights to the contacts the user previously identified when setting up the “watch” function in the first instance (e.g., a telephone message to the traveler and the driver assigned to pick the traveler up at the airport, an e-mail to an office assistance, superior or spouse, etc.) 530, 532, 534, 536, 540,544,548. Unlike status systems that are currently offered by some airlines, the “watch” service of according to a preferred embodiment of the invention allows the user (1) to regularly add or subtract designated contract notifications to each specified trip; and (2) to react immediately to the information, for example, by interacting with the system to obtain information about alternative flights.

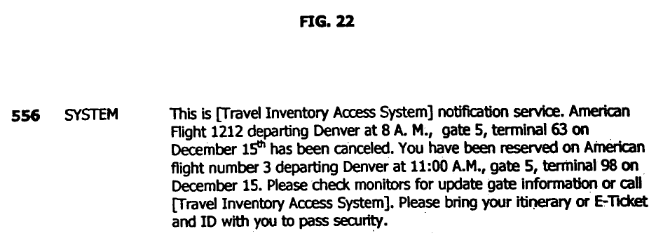

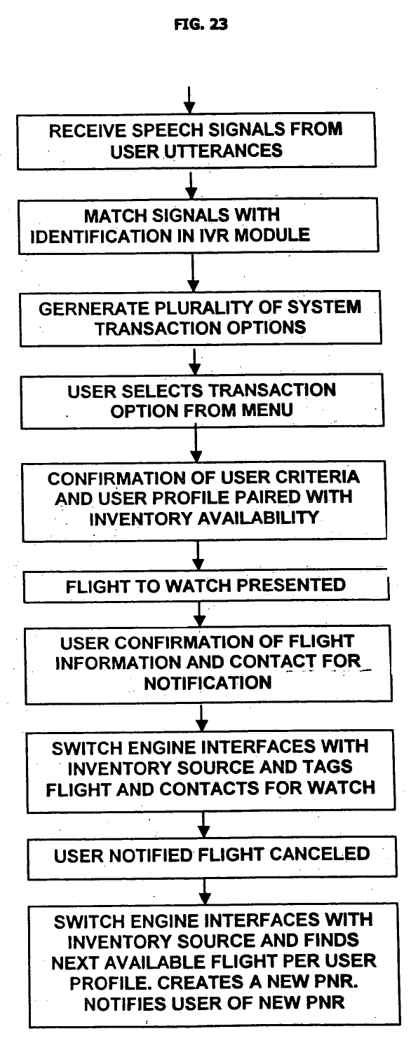

In a preferred embodiment of a system 10 according to the invention in which a “watch” function is available, if one of the flights that is the subject of a watch is cancelled by the airline, the system 10 can search the airline's inventory in the GDSs or CRSs, locate the next available flight, and automatically reserve for the traveler a substitute reservation on that flight. An example of the type of notification that might be provided by this preferred embodiment of the invention is shown in FIG. 22 and FIG. 23.

In this embodiment, the system 10 has a feature whereby, when a traveler's airline flight has been cancelled, the system 10 will acquire the cancellation information, automatically create an alternative itinerary for the traveler in which the traveler is scheduled on the next available flight. When the system has accomplished this, the cancellation information together with the alternative next available flight information is relayed to the user via the client interface 12. The user is prompted by the system 10 to either complete the transaction associated with itinerary for the next available scheduled flight, or to reject it.

Obtaining Information About A Scheduled Airline Flight (“FLIFO”)

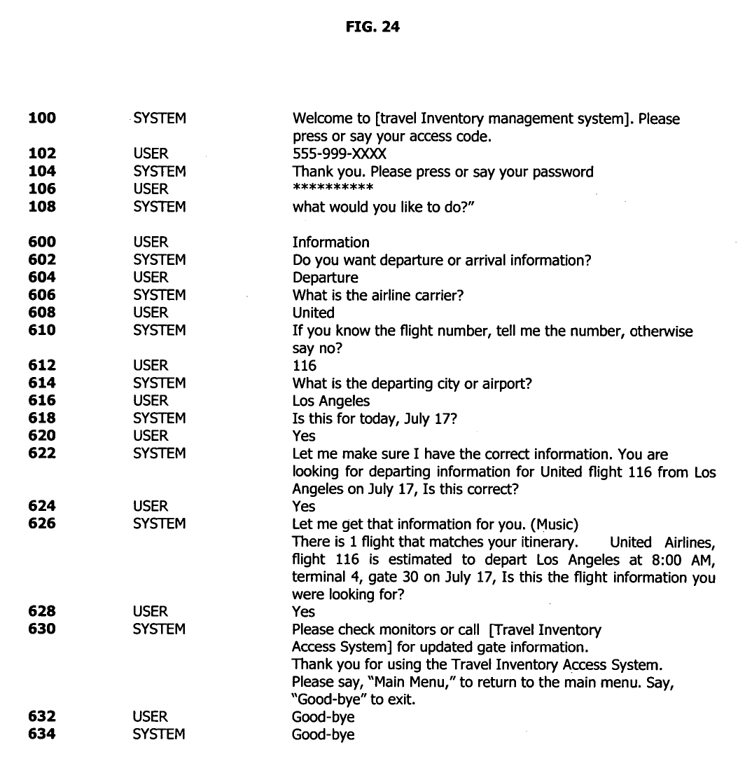

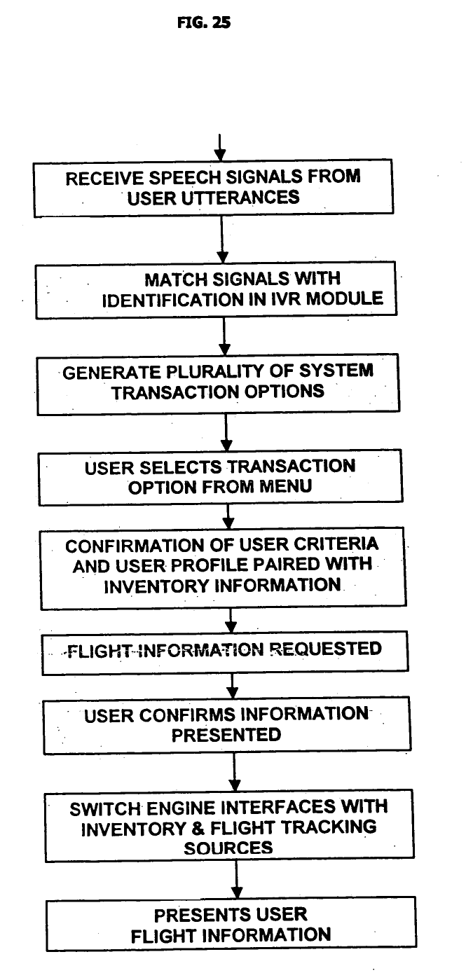

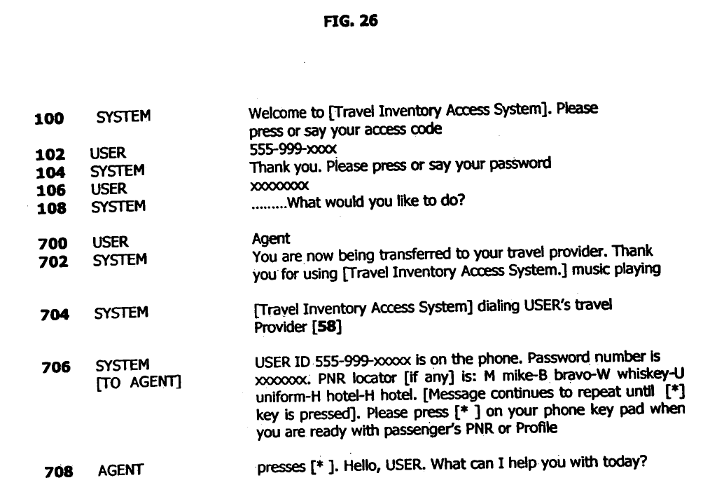

A further transaction option of a system 10 according to the invention is the option to ascertain information about an item stored in the suppliers' inventories that is not the subject of a pre-existing itinerary or PNR. This feature of the system 10 now will be explained with reference to FIGS. 24 and 25. FIG. 24 is an example of a system script corresponding to the “information” command option. The process by which a user retrieves information concerning an inventory item (e.g., a scheduled airline flight) is illustrated schematically in FIG. 25.

This option can be invoked by the user's utterance of the command “information” 600. The “information” command allows a user to access information regarding a specific item, for example a scheduled flight's estimated time of arrival or departure; gate and terminal assignments and the make and mode of the aircraft designated by the airline for a particular flight.

Preliminarily, the user is prompted by the system 10 to provide information concerning the item a user wants to know more about. In the example given in FIG. 24, system 10 prompts the user to provide information about the item, e.g., the expected arrival or departure time 602, 604, the airline carrier 606, 608, the flight number 610, 612, the departing city or airport 614, 616, and the date of the flight 618. The system 10 collects the information and plays back the collected information to the user for confirmation 620. The system 10 interacts with the user until the point where the system can confirm that it understands what information the user is seeking. When the user acknowledges that the system 10 has interpreted what the user is seeking correctly 622, the system 10 initiates a process of searching the suppliers' inventory, based upon the information provided by the user, via the switch engine 40 and tracking module 64 and through the switch engine gateway 63 to the GDSs or CRSs that are implicated by the user's inquiry. The information responsive to the user's inquiry is then relayed back to the user through the switch engine gateway 63, tracking module 64 and switching engine 40, to the speech synthesis module 18 and output port 16, to the client interface 12, e.g., the user's telephone 628. The system 10 then completes the transaction and, optionally, also relays a “remark” to the user or to the traveler (if the user and the traveler are distinct from one another), advising that the system 10 should be further queried for updated information.

Connecting To A Travel Agency Or To A Corporate Travel Department

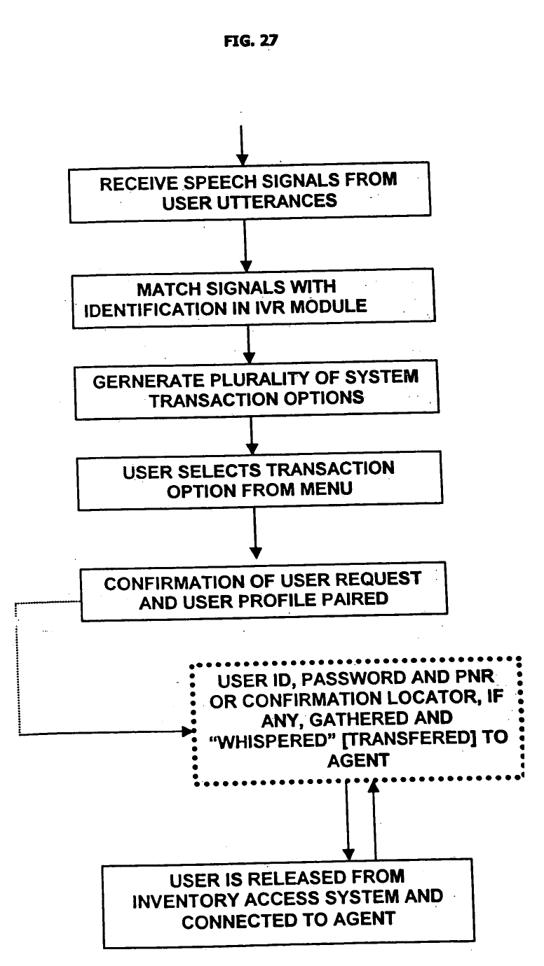

In a preferred embodiment of an inventory access system 10 according to the invention, and referring now to FIG. 26 and FIG. 27 at any time after a user is confirmed by the system 10 as an authorized user, the user can utter the universal command “agent” 700 in order to invoke immediate human assistance with anything associated with a particular itinerary. The inventory access system 10 will retrieve from the library 22 information sufficient to identify the travel agency 58 or Corporate Travel Department 60 with the designated pseudo city code 72 and the travel agency's or the CTD's terminal address. In a currently preferred embodiment of the system 10 according to the invention, this retrieval process takes on the order of thirty seconds to one and a half minutes to complete. While the user is waiting to speak to an agent, “hold” music or advertisements may be transmitted by the system 10 to the client interface 12, e.g., the user's telephone. The system 10 will dial the travel agency's or CTD's telephone number. When a connection with the travel agency 58 or CTD 60 is established, the system 10 will “whisper” the available data about the traveler about the traveler's itinerary or the traveler's PNR locator 70 (if available) 704 over a data line 62 to the travel agency 58 or CTD 60. Alternatively, the information can be sent to the travel agency 58 or CTD 60 by the system 10 via some other means, such as via an Internet or intranet connection.

When a human assistant (e.g., a travel agent) accesses the information sent by the system 10, the system 10 prompts the assistant to take some action, e.g., press the star (“*”) button on the telephone key pad, or click on a “connect” icon displayed on a computer screen 706. When the human assistant takes the prompted action, the user is connected via the telephone with that person. In a presently preferred embodiment of a system 10 according to the invention, the user is concurrently disconnected with the system 10 708.

Receiving A Courtesy Message About A Pre-Existing Itinerary

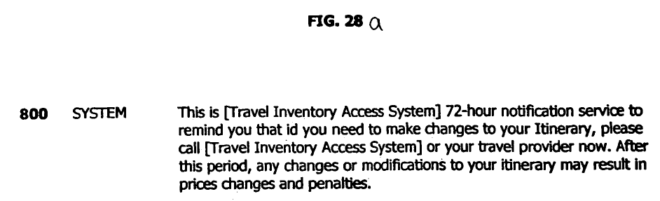

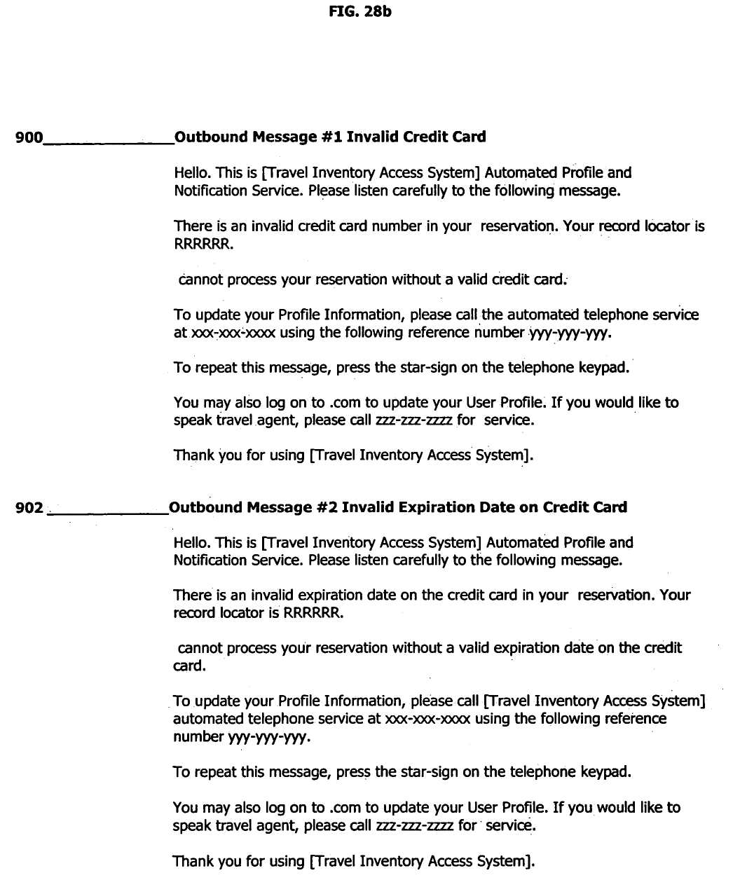

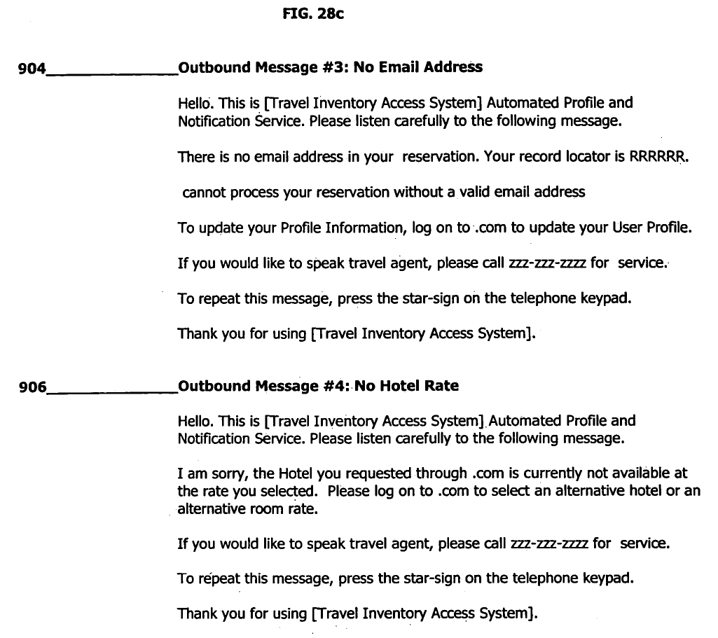

Suppliers or agency users who want to foster good will and to help customers reduce or optimize the costs routinely incurred in procuring travel may offer, a “courtesy” message 800 to clients (i.e., system users and travelers). This feature of the system 10 now will be explained with references to FIG. 28a. Information concerning PNRs that have been created by travel agencies or CTDs, other than through use of the system 10, can be sent to the system 10 via incoming port 12 or one or more connections between the travel agency 58, the inventory suppliers (i.e., the GDSs 52 and the CRSs 50) and the system 10. Once the system 10 has this information, the system 10, via the switch engine gateway 63 and switch engine 40 will cause a “remark” to be sent to the user and/or the user's travel agency or CTD (in the case where the user is not the traveler) through the speech synthesis module 18, and through the output ports 16 to the travel agency and through to the client interface 12, e.g., the user's telephone. The remark is sent to user 72 hours prior to the departure of the first flight segment in the traveler's PNR. The remark would include language similar to the following: “Please make any changes to your itinerary now. Any delays could result in penalties and prices changes.”

System Prompts To Update Stale User Information In Travel Profiles

Travel agencies or CTDs commonly monitor various queues that are located in GDSs in which PNRs have been sent that exhibit some sort of problem, e.g., the credit card number for the traveler is past the expiration date that is of record. Travel agencies and CTDs, in turn, commonly maintain queues that correspond to these problem PNRs for their clients, so that some corrective action can be taken with respect to the same. The travel agency or CTD typically maintains separate problem queues for different problems, for example, a travel agency or CTD may have one queue in which PNRs are sent that contain credit card information that is outdated (e.g., the credit card expiration date has passed), and another queue for PNRs that have address or contact information for a traveler that conflicts other information in the travel agency's or CTD's files for the traveler.

In order for transactions involving these PNRs to be completed and subsequently successfully processed in back-end accounting procedures, whatever the problem is that caused the PNR to be sent to the problem queue must be corrected. Prior to the system according to the invention, such corrective action was labor intensive, since it usually required individual attention from an agent. In large travel agencies there are as many as fourteen queues within the GDSs that the agencies monitor to take corrective action with respect to problem PNRs. In these circumstances, a traveler or traveler's agent traditionally has had only one or two means for updating the missing information: (1) speaking to the traveler directly and causing the affected PNR to be modified to reflect the updated information; or (2) contacting the traveler via the travel agency's website or via an on-line booking service supported by the travel agency.

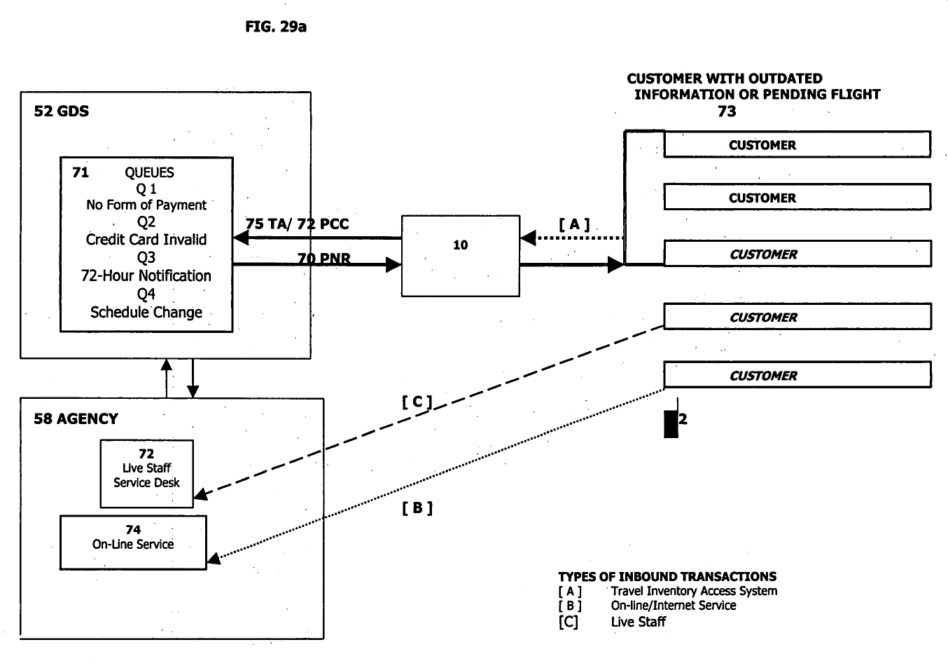

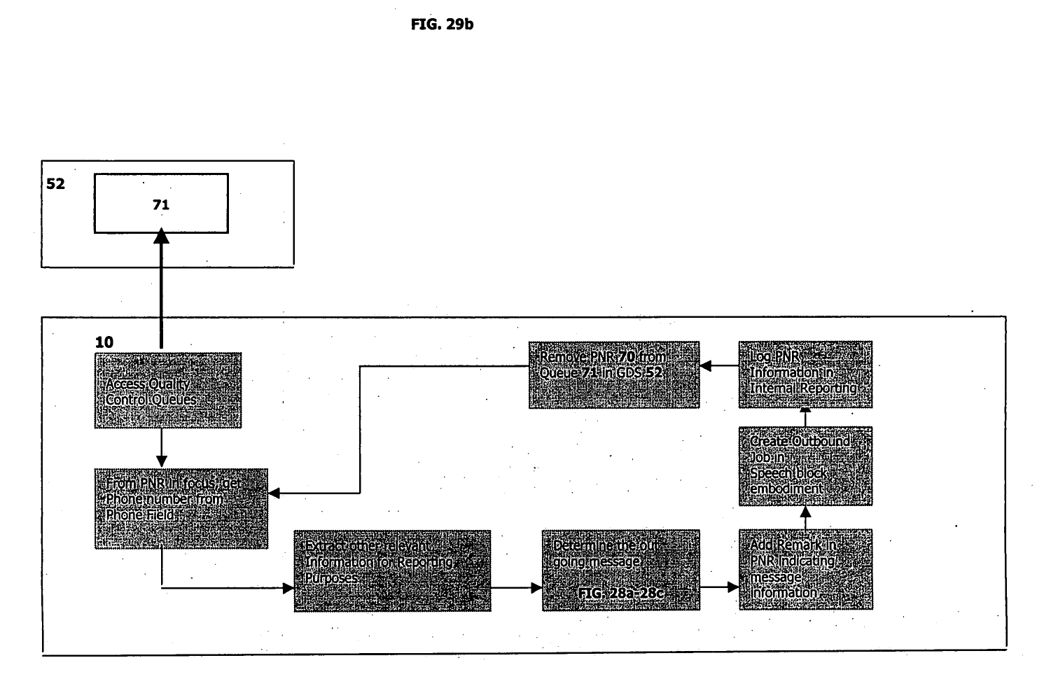

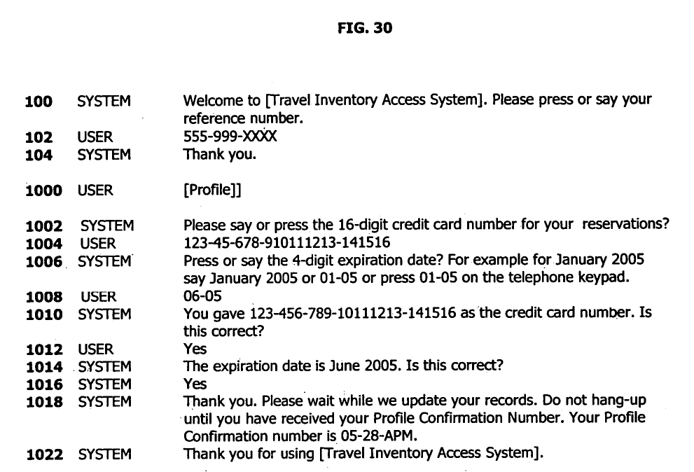

In one preferred embodiment of a system 10 according to the invention, a feature exists whereby corrective action can be initiated and followed up on with respect to problem PNRs with no action required from a human assistant at a travel agency or CTD. This feature of the system 10 reduces the workload that human assistants have to bear that is associated with manual and redundant tasks, e.g., outbound calls from travel agency staff to travel agency customers, increases accuracy and efficiency with which users and travelers can be notified of outdated information, and allows a travel agency or CTD to use their human assistants' time for performing tasks that are better suited to their level of skill, and enhances customer loyalty and satisfaction. This feature now will be described with reference to FIGS. 28b-28c, FIGS. 29a-29b and FIG. 30. FIGS. 28b-28c are examples of a possible outbound system messages associated with the corrective action feature according to the system of the invention. The process by which such corrective action is carried out by the system is illustrated schematically in FIGS. 29a-29b. FIG. 30 is an example of a system script corresponding to the courtesy message feature of the invention, showing possible user responses.

The system 10 in FIG. 29b monitors the problem PNRs that have been routed to the travel agency or CTD problem queues from the GDSs. The system 10 reads or extracts the traveler's phone number from the PNR and determines which information in the PNR or the associated travel profile is missing or requires updating. When the system 10 has completed this process and identified the problem that needs correcting, the problem is matched by the system 10 with the appropriate outbound message to be sent to the user or traveler via the telephone lines 800, 900, 902, 904, 906. The system 10, via the switch engine gateway 63 and switch engine 40, will send the appropriate scripted remark through the output ports 16 to the client interface 12, e.g., the user's telephone 12. The remark will be recorded in the PNR and the PNR will be monitored until the problem has been corrected. The user or traveler will continue to be notified periodically by the system 10 of the problem via the scripted messages and the client interface 12 until the user or traveler has taken the appropriate corrective action with the system 10 or with his or her travel agent and the problem PNR is removed from the travel agency's or CTD's problem queue.

Referring now to FIG. 30, a user may use the voice-command “profile” 1000 to activate the corrective action option. Then the user speaks or enters via a keypad a valid 16-digit credit card number and 4-digit expiration date in response to voice prompts from the system. The system 10 then “populates” the pertinent PNR or travel profile with the modified information and replaces the existing PNR in the travel agency or CTD's problem queue with the PNR with the modified or corrected information. The system accomplishes this through processes involving the switch engine 40, the gateway 63, the speech synthesis module 18, and the input ports 14 and output ports 16. Once the corrective action has been taken by the user, the updated PNR is no longer monitored as a problem PNR by the system 10. All of the corrective action activity undertaken by the system 10 is recorded and collected for reporting purposes.

Although the invention has been described in language specific to inventory access in the travel industry, and with respect to particular system components and functions, it is to be understood that the invention defined in the appended claims is not necessarily limited to the specific industry, components or functions described. Therefore, the specific type of inventory, components and functions are disclosed as exemplary embodiments with which the claimed invention may be implemented.

Further, the various embodiments described above are provided by way of illustration only and should not be construed to limit the invention. Those skilled in the art will readily recognized various modifications and changes that may be made to the present invention without following the example embodiments and applications illustrated and described herein, and without departing from the true spirit and scope of the present invention, which is set forth in the following claims.

What is claimed is:

1. An inventory access system for accessing products and services in multiple inventories with a high degree of automation, the system comprising:
(a) at least one user interface that transmits data to and receives data from a user via a telephone;
(b) a speech synthesis module that translates information received from the user interface;
(c) an inventory interface that transmits data between the inventory access system and one or more inventory databases, wherein the inventory databases containing information about items in an inventory, and wherein the inventory interface communicates translated instructions from the speech synthesis module to the inventory databases;
(d) a library containing one or more library databases, wherein the library databases have criteria with which to search the inventory databases, and wherein the library is accessed in response to instructions by the user through the user interface; and
(e) a switch engine that directs and controls the flow of information between the at least one user interface, the inventory interface, and the library,
wherein the user is provided with access to one or more items in the inventory, and wherein a user can utilize the user interface to contact a live travel attendant if so desired.

2. The inventory access system of claim 1, wherein the inventory interface also transmits and receives data from the inventory databases, which contain information about items in an inventory, to a third party individual or organization.

3. The inventory access system of claim 1, wherein the inventory comprises one or more items selected from the group consisting of: open seats on airline flights, available rooms in hotels or resorts, and available automobiles in a rental car fleet.

4. The inventory access system of claim 1, wherein the at least one user interface is an integrated voice recognition module.

5. A method for facilitating voice-activated inventory access using a system that has automated primary capabilities and live assistance capabilities for secondary support, the method comprising:
receiving speech signals from user utterances;
matching the speech signals using a voice recognition module;
generating a menu of system transaction options for the user from a library, wherein the library includes at least one database;
receiving a user selection from the menu of system transaction options;
presenting an inventory to the user that correlates with the user's menu selection;
receiving a user selection from the inventory presented;
interfacing with inventory and flight tracking sources; and
confirming the user selected inventory, wherein the user is able to exit the automated system and receive live assistance on demand.

6. The method of claim 5, further comprising: creating a user profile that contains basic identifying information.

7. The method of claim 6, further comprising: storing the user profile in an identification/authorization database.

8. The method of claim 5, wherein the user utterances are received from a user interface.

9. The method of claim 8, wherein the user interface is a telephone.

10. The method of claim 5, wherein the matching of the speech signals by the voice recognition module facilitates voice verification that the user is an authorized user of the system.

11. The method of claim 5, wherein an access code is used to verify that the user is an authorized user of the system.

12. The method of claim 5, further comprising: creating a user template that is accessed once the user identity has been verified, wherein the user template includes rules and information regarding the user's profile.

13. The method of claim 5, wherein the inventory is generated from multiple suppliers of travel products and travel related services.

14. The method of claim 5, wherein the system uses voice prompted scripts to communicate with the user.

15. The method of claim 5, wherein the inventory access system facilitates ascertaining the availability and pricing information of one or more seats on airline flights.

16. The method of claim 5, wherein the inventory access system further comprises a library of information that includes a variety of databases.

17. The method of claim 5, wherein the system incorporates a switch engine that accepts and processes information from the voice recognition module and the library, and also accepts and processes information concerning inventory of a supplier's travel products and services.

18. The method of claim 5, wherein the system further comprises an adjunct client interface that transmits copies of trip itineraries and receipts for completed transaction.

19. The method of claim 5, wherein the method facilitates: creating a trip itinerary in response to a “schedule” voice command.

20. The method of claim 5, wherein the method facilitates voice commands that include at least one command from the group consisting of: “agent,” “repeat,” “start over,” “good-bye,” and “main menu.”

21. The method of claim 5, wherein the method facilitates retrieving information about an existing itinerary.

22. The method of claim 5, wherein the method facilitates canceling an existing itinerary.

23. The method of claim 5, wherein the method facilitates modifying a trip itinerary.

24. The method of claim 5, wherein the method facilitates setting a watching function for an arriving or departing flight that monitors the status of the flight and reports any significant changes to the user.

25. The method of claim 5, wherein the method facilitates obtaining information about a scheduled airline flights.

26. The method of claim 5, wherein the method facilitates receiving courtesy message about an existing trip.

27. The method of claim 5, wherein the inventory and flight tracking sources include at least one from the group consisting of: an airlines computer reservation system, a global distribution system, an airline inventory of available seats, and hotel inventory of open rooms.

28. A voice-activated inventory access system that has automated primary capabilities and live assistance capabilities for secondary support, wherein the system accesses products and services in multiple inventories with a high degree of automation, the system comprising:
a voice-based user interface that facilitates communicating information to and from a user;
a voice recognition module that translates the information received from the user interface;
an inventory interface, wherein the inventory interface communicates data between the inventory access system and one or more inventory databases, the inventory databases containing information relating to items in an inventory;
a library containing one or more library databases, wherein the library databases at least include information relating to user identification and access protocols, and wherein the library databases also include criteria for searching the inventory databases; and
a switch module, wherein the switch module directs and controls the flow of information between the inventory interface, the library, and user interface via the voice recognition module;
wherein the user selects a system transaction from a menu in the library, is provided with access to one or more items in the inventory, selects an item from the inventory presented, and receives confirmation of the user selected inventory after the system has interfaced with the inventory databases, and
wherein a user can utilize the user interface to contact a live agent at any time.

29. The system of claim 28, wherein the library includes a user profile that contains basic identifying information.

30. The system of claim 29, wherein the user profile is stored in an identification/authorization database within the library.

31. The system of claim 28, wherein the user interface is a telephone.

32. The system of claim 28, wherein the voice recognition module provides voice verification that the user is an authorized user of the system.

33. The system of claim 28, wherein an access code is used to verify that the user is an authorized user of the system.

34. The system of claim 28, wherein the library includes a user template that is accessed once the user identity has been verified, wherein the user template includes rules and information regarding the user's profile.

35. The system of claim 28, wherein the inventory, which is accessed through the inventory interface, is generated from multiple suppliers of travel products and travel related services.

36. The system of claim 28, wherein the system uses voice prompted scripts to communicate with the user.

37. The system of claim 28, wherein the system facilitates ascertaining the availability and pricing information of one or more seats on airline flights.

38. The system of claim 28, further comprising an adjunct client interface that transmits electronic copies of trip itineraries and receipts to the user.

39. The system of claim 28, wherein a user initiates creating a trip itinerary in response to a “schedule” voice command.

40. The system of claim 28, wherein the system utilizes voice commands that include at least one command from the group consisting of: “agent,” “repeat,” “start over,” “good-bye,” and “main menu.”

41. The system of claim 28, wherein the system facilitates retrieving information about an existing itinerary.

42. The system of claim 28, wherein the system facilitates canceling an existing itinerary.

43. The system of claim 28, wherein the system facilitates modifying a trip itinerary.

44. The system of claim 28, wherein the system facilitates setting a watching function for an arriving or departing flight that monitors the status of the flight, and reporting any significant changes to the user.

45. The system of claim 28, wherein the system facilitates obtaining information about a scheduled airline flights.

46. The system of claim 28, wherein the system facilitates receiving courtesy message about an existing trip.

47. The system of claim 28, wherein the inventory items include at least one item selected from the group consisting of: an airlines computer reservation system, a global distribution system, an airline inventory of available seats, and hotel inventory of open rooms.

48. The system of claim 28, wherein the system facilitates rescheduling of airline flights cancelled by an airline.
